(19) United States
(12) Patent Application Publication
(10) Pub. No.: US 2026/0353420 A1
(43) Pub. Date: Nov. 5, 2026

(54) COLLISION DETECTION BASED SPS RESOURCE RESELECTION

(71) Applicant: QUALCOMM Incorporated, San Diego, CA (US)

(72) Inventors: Hui GUO, Beijing (CN); Tien Viet NGUYEN, Bridgewater, NJ (US); Shuanshuan WU, San Diego, CA (US); Kapil GULATI, Belle Mead, NJ (US)

(21) Appl. No.: 19/484,645

(22) PCT Filed: Jul. 25, 2023
(86) PCT No.: PCT/CN2023/109035

§ 371 Date: Nov. 14, 2025

(51) Int. Cl. H04W 72/40; H04B 17/318; H04W 92/18

(52) U.S. Cl. CPC H04W 72/40; H04B 17/328; H04W 92/18

(57) ABSTRACT

A first first-stage-sidelink control information (first SCI-1) and data are transmitted, the first SCI-1 comprising a first resource reservation information reserving a first resource in a first semi-persistent scheduling (SPS) process and omitting a first resource reservation period (RSVP). A subsequent second SCI-1 and the data are transmitted, the second SCI-1 comprising a second resource reservation information reserving a subsequent resource in the first SPS process and comprising a second RSVP having a second RSVP value indicative of a semi-persistent scheduling of the data. One or more other apparatus' SCI-1 are sensed. A first SCI-1 and data in selected resources in a plurality of SPS processes are transmitted. A timer/counter is initiated at a start of a first SPS process and at least one SPS process is changed based at least in part on an elapsed time/count indicated by the timer/counter.

### TECHNICAL FIELD

The technology discussed below relates generally to wireless communication networks, and more particularly, to collision detection based semi-persistent scheduling (SPS) resource reselection.

### INTRODUCTION

The 5G New Radio (NR) mobile telecommunication system can provide higher data rates, lower latency, and improved system performance than previous generation systems such as Long Term Evolution (LTE) communication systems. Improvements in 5G NR extend to autonomous communication between user equipment, for example, in vehicle to everything (V2X) applications, where 5G NR V2X systems offer lower latency, higher reliability, and higher throughput that older LTE cellular-V2X (C-V2X) systems. Improvements to 5G NR V2X also include the use of groupcast and unicast communications. In 5G NR V2X, two modes are available. Mode 1 relates to in-network coverage operation, where a base station manages sidelink resources for use among a plurality of user equipment (UEs). Mode 2 relates to out-of-network coverage (i.e., outside of a range of a base station) operation, where UEs autonomously select resources. As the number of UEs utilizing Mode 2 operations increases, collisions between UEs attempting to use the same resources in any given sidelink resource pool may also increase. Scientists and engineers continue to investigate options to avoid collisions between UEs sharing limited resources.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a method, at an apparatus, is disclosed. The method comprises transmitting in a first resource, a first first-stage-sidelink control information (first SCI-1) and data, the first SCI-1 comprising a first resource reservation information reserving the first resource in a first semi-persistent scheduling (SPS) process and omitting a first resource reservation period (RSVP), and transmitting in at least one subsequent resource, a second first-stage-sidelink control information (second SCI-1) and the data, the second SCI-1 comprising a second resource reservation information reserving the at least one subsequent resource in the first SPS process and comprising a second RSVP having a second RSVP value greater than zero and indicative of a semi-persistent scheduling of the data.

In another example, an apparatus, is disclosed. The apparatus comprises one or more memories, and one or more processors. In the example, the one or more memories, and one or more processors are configured to, individually or collectively, based at least in part on information stored in the one or more memories: transmit in a first resource, a first first-stage-sidelink control information (first SCI-1) and data, the first SCI-1 comprising a first resource reservation information reserving the first resource in a first semi-persistent scheduling (SPS) process and omitting a first resource reservation period (RSVP), and transmit in at least one subsequent resource, a second first-stage-sidelink control information (second SCI-1) and the data, the second SCI-1 comprising a second resource reservation information reserving the at least one subsequent resource in the first SPS process and comprising a second RSVP having a second RSVP value greater than zero and indicative of a semi-persistent scheduling of the data.

In another example a method at an apparatus is disclosed. In the example, the method comprises sensing, by receiving, one or more other apparatus' first-stage-sidelink control information (SCI-1) in one or more resources available for sidelink communication, in a sensing window, transmitting, in a resource selection window, a first SCI-1 and data in selected resources in a plurality of semi-persistent scheduling (SPS) processes, each of the selected resources based on the sensing in the sensing window, initiating a timer/counter at a start of a first SPS process of the plurality of SPS processes, and changing at least one SPS process of the plurality of SPS processes based at least in part on an elapsed time/count indicated by the timer/counter.

In still another example, an apparatus is disclosed. The apparatus comprises one or more memories, and one or more processors. In the example, the one or more memories, and one or more processors are configured to, individually or collectively, based at least in part on information stored in the one or more memories: sense, by receiving, one or more other apparatus' first-stage-sidelink control information (SCI-1) in one or more resources available for sidelink communication, in a sensing window, transmit, in a resource selection window, a first SCI-1 and data in selected resources in a plurality of semi-persistent scheduling (SPS) processes, each of the selected resources based on the sensing in the sensing window, initiate a timer/counter at a start of a first SPS process of the plurality of SPS processes, and change at least one SPS process of the plurality of SPS processes based at least in part on an elapsed time/count indicated by the timer/counter.

These and other aspects will become more fully understood upon a review of the detailed description, which follows. Other aspects, features, and examples will become apparent to those persons having ordinary skill in the art, upon reviewing the following description of specific examples in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In a similar fashion, while examples described herein may be discussed below in terms of specific device, system, or method examples, such exemplary examples can be implemented in various devices, systems, and methods.

### BRIEF DESCRIPTION OF THE DRAWINGS

FIG. 1 is a schematic illustration of an example of a wireless communication system according to some aspects of the disclosure.

FIG. 2 is an expanded view of an exemplary subframe, showing an orthogonal frequency division multiplexing (OFDM) resource grid according to some aspects of the disclosure.

FIG. 3 is a diagram illustrating an example of a wireless communication network employing sidelink communication according to some aspects of the disclosure.

FIG. 4 is an illustration of a portion of a resource grid associated with an example of a 5G New Radio vehicle to everything sidelink Mode 2 resource reservation process according to some aspects of the disclosure.

FIG. 5 is an illustration depicting four semi-persistent scheduling (SPS) processes according to some aspects of the disclosure.

FIG. 6 is an illustration depicting three SPS processes according to some aspects of the disclosure.

FIG. 7 is an illustration depicting three SPS processes according to some aspects of the disclosure.

FIG. 8 is a block diagram illustrating an example of an apparatus (e.g., a wireless communication device, a user equipment, a mobile device, a vehicle) employing one or more processors and one or more memories according to some aspects of the disclosure.

FIG. 9 is a flow chart illustrating an example method at an apparatus according to some aspects of the disclosure.

FIG. 10 is a flow chart illustrating an example method at an apparatus according to some aspects of the disclosure.

FIG. 11 is a flow chart illustrating an example method at an apparatus according to some aspects of the disclosure.

FIG. 12 is a flow chart illustrating an example method at an apparatus according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to persons having ordinary skill in the art that these concepts may be practiced without these specific details. In some instances, well-known structures and components are shown in block diagram form in order to avoid obscuring such concepts.

While aspects and examples are described in this application by illustration to some examples, persons having ordinary skill in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component-based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for the implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station or UE), end-user devices, etc. of varying sizes, shapes, and constitutions.

In a 5G NR V2X sidelink Mode 2 (time-frequency) resource reservation procedure, a particular UE may establish a sensing window and a resource selection window. The UE may project reference signal received power (RSRP) measurements associated with first-stage-sidelink control information (SCI-1) signaling received from neighboring UEs in resources in the sensing window onto corresponding resources available for sidelink communication in the resource selection window. The UE may determine that respective ones of the neighboring UEs are using the corresponding resources in the resource selection window for their transmissions and may therefore avoid scheduling transmissions on those corresponding resources. The UE may select other, available, resources in the resource selection window for its transmission of an SCI-1 signal and an initial transmission of a transport block. Using a semi-persistent scheduling (SPS) procedure, the UE may utilize the SCI-1 to reserve the available resources for the initial transmission of the transport block and indicate a period for N periodic retransmissions of the transport block in N resources. The same N resources may be reserved in a plurality of SPS processes throughout a total period during which the transport block is transmitted and retransmitted.

Consequently, initial transmission in a first SPS process reserves resources in the first SPS process and signals the reservation of corresponding resources in a plurality of SPS processes to come. The SPS process repeats itself until an SPS resource reselection is triggered. However, an initial transmission in the first SPS process that identifies the period of the plurality of SPS processes may be prone to collision. While other UEs may detect potential resource collisions for subsequent transmissions, the initial transmission of the period may collide with the other UEs' reservations, which may be broadcast at the same time as the reservation of the particular UE. Some examples of how to detect potential collisions and avoid potential collisions may be described herein.

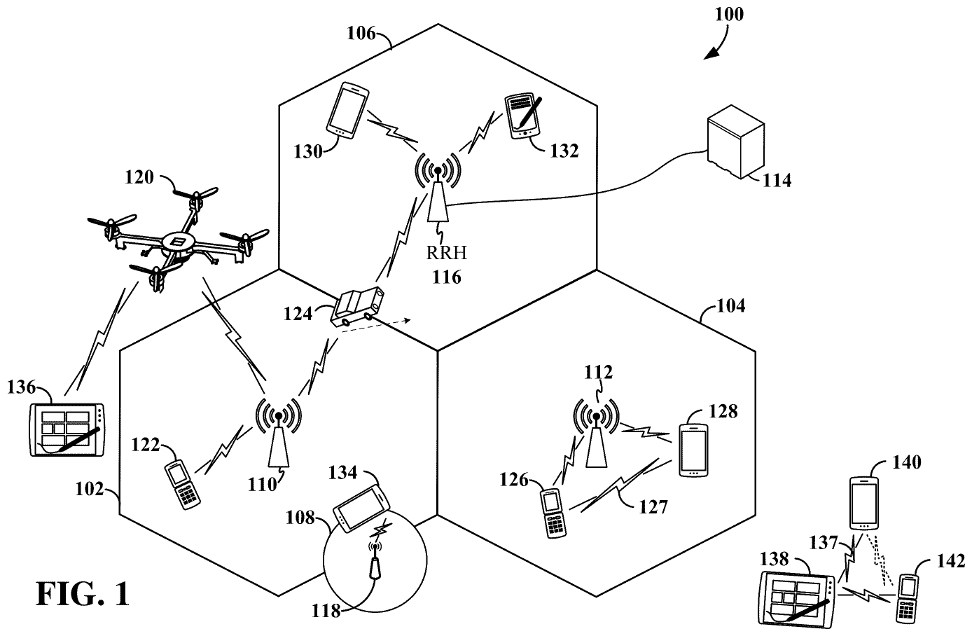

The various concepts presented throughout this disclosure may be implemented across a broad variety of telecommunication systems, network architectures, and communication standards. Referring now to FIG. 1, as an illustrative example without limitation, a schematic illustration of a radio access network 100 is provided. The radio access network (RAN) 100 may implement any suitable wireless communication technology or technologies to provide radio access. As one example, the RAN 100 may operate according to 3^{rd} Generation Partnership Project (3GPP) New Radio (NR) specifications, often referred to as 5G. As another example, the RAN 100 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

The geographic region covered by the radio access network 100 may be divided into a number of cellular regions (cells) that can be uniquely identified by a user equipment (UE) based on an identification broadcasted over a geographical area from one access point or base station. FIG. 1 illustrates cells 102, 104, 106, and cell 108, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

In general, a respective network entity serves each cell. Broadly, a network entity is a network element in a radio access network responsible for radio transmission and reception in one or more cells to or from a UE. A network entity may also be referred to by persons having ordinary skill in the art as a base station (BS), base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a network entity may include two or more TRPs that may be collocated or non-collocated. Each TRP may communicate on the same or different carrier frequency within the same or different frequency band. In examples where the RAN 100 operates according to both the LTE and 5G NR standards, one of the TRPs may be an LTE base station, while another TRP may be a 5G NR base station. In some examples, a network entity may be configured in an aggregated or monolithic base station architecture or in a disaggregated base station architecture.

Various network entity (e.g., base station) arrangements can be utilized. For example, in FIG. 1, two base stations 110 and 112 are shown in cells 102 and 104; and a third base station 114 is shown controlling a remote radio head (RRH) 116 in cell 106. That is, a base station can have an integrated antenna or can be connected to an antenna or RRH by feeder cables. In the illustrated example, the cells 102, 104, and 106 may be referred to as macrocells, as the base stations 110, 112, and 114 support cells having a large size. Further, a base station 118 is shown in the cell 108 which may overlap with one or more macrocells. In this example, the cell 108 may be referred to as a small cell (e.g., a microcell, picocell, femtocell, home base station, home Node B, home eNode B, etc.), as the base station 118 supports a cell having a relatively small size. Cell sizing can be done according to system design as well as component constraints.

It is to be understood that the radio access network 100 may include any number of wireless base stations and cells. Further, a relay node may be deployed to extend the size or coverage area of a given cell. The base stations 110, 112, 114, 118 provide wireless access points to a core network for any number of mobile apparatuses.

FIG. 1 further includes an unmanned aerial vehicle (UAV) 120, which may be, for example, a drone or quadcopter. The UAV 120 may be configured to function as a base station, or more specifically as a mobile base station. That is, in some examples, a cell may not necessarily be stationary, and the geographic area of the cell may move according to the location of a mobile base station such as the UAV 120.

In general, base stations may include a backhaul interface for communication with a backhaul portion (not shown) of the network. The backhaul may provide a link between a base station and a core network (not shown), and in some examples, the backhaul may provide interconnection between the respective base stations. The core network may be a part of a wireless communication system and may be independent of the radio access technology used in the radio access network. Various types of backhaul interfaces may be employed, such as a direct physical connection, a virtual network, or the like using any suitable transport network.

The RAN 100 is illustrated as supporting wireless communication for multiple mobile apparatuses. A mobile apparatus is commonly referred to as user equipment (UE) in standards and specifications promulgated by the 3rd Generation Partnership Project (3GPP), but may also be referred to by persons having ordinary skill in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus that provides a user with access to network services.

Within the present document, a “mobile” apparatus need not necessarily have a capability to move and may be stationary. The term mobile apparatus or mobile device broadly refers to a diverse array of devices and technologies. For example, some non-limiting examples of a mobile apparatus include a mobile device, a cellular (cell) phone, a smartphone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT), all of which may operate via Uu reference points and/or PC5 (sidelink) reference points. A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, etc. Still further, a mobile apparatus may provide connected medicine or telemedicine support, i.e., health care at a distance. Still further, a mobile apparatus may be referred to as a telehealth device, which may include telehealth monitoring devices and telehealth administration devices, whose communication may be given preferential treatment or prioritized access over other types of information, e.g., in terms of prioritized access for transport of critical service data, and/or relevant QoS for transport of critical service data.

Within the RAN 100, the cells may include UEs that may be in communication with one or more sectors of each cell. For example, UEs 122 and 124 may be in communication with base station 110; UEs 126 and 128 may be in communication with base station 112; UEs 130 and 132 may be in communication with base station 114 by way of RRH 116; UE 134 may be in communication with base station 118; and UE 136 may be in communication with mobile base station 120. Here, each base station 110, 112, 114, 118, and 120 may be configured to provide an access point to a core network (not shown) for all the UEs in the respective cells. In some examples, the mobile base station 120 (e.g., the UAV, the quadcopter) can be a mobile network node and may be configured to function as a UE. For example, the UAV 120 may operate within cell 102 by communicating with base station 110.

Wireless communication between a RAN 100 and a UE (e.g., UE 122 or 124) may be described as utilizing an air interface. Transmissions over the air interface from a base station (e.g., base station 110) to one or more UEs (e.g., UE 122 and 124) may be referred to as downlink (DL) transmission. In accordance with certain aspects of the present disclosure, the term downlink may refer to a point-to-multipoint transmission originating at a scheduling entity (described further below; e.g., base station 110). Another way to describe this scheme may be to use the term broadcast channel multiplexing. Transmissions from a UE (e.g., UE 122) to a base station (e.g., base station 110) may be referred to as uplink (UL) transmissions. In accordance with further aspects of the present disclosure, the term uplink may refer to a point-to-point transmission originating at a scheduled entity (described further below; e.g., UE 122).

For example, DL transmissions may include unicast, groupcast, or broadcast transmissions of control information and/or traffic information (e.g., user data traffic) originating at a base station (e.g., base station 110) to one or more UEs (e.g., UEs 122 and 124), while UL transmissions may include transmissions of control information and/or traffic information originating at a UE (e.g., UE 122). In addition, the uplink and/or downlink control information and/or traffic information may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

The air interface in the RAN 100 may utilize one or more multiplexing and multiple access algorithms to enable simultaneous communication of the various devices. For example, 5G NR specifications provide multiple access for UL or reverse link transmissions from UEs 122 and 124 to base station 110, and for multiplexing DL or forward link transmissions from the base station 110 to UEs 122 and 124 utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 110 to UEs 122 and 124 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Further, the air interface in the RAN 100 may utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, at some times the channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex (FD).

In various implementations, the air interface in the RAN 100 may utilize licensed spectrum, unlicensed spectrum, or shared spectrum. Licensed spectrum provides for the exclusive use of a portion of the spectrum, generally by virtue of a mobile network operator purchasing a license from a government regulatory body. Unlicensed spectrum provides for shared use of a portion of the spectrum without the need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple radio access technologies (RATs). For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into the mid-band frequencies. In addition, higher frequency bands are currently being explored to extend 5G NR operation beyond 52.6 GHz. For example, three higher operating bands have been identified as frequency range designations FR4-a or FR4-1 (52.6 GHZ-71 GHz), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In some examples, access to the air interface may be scheduled, wherein a scheduling entity (e.g., a base station) allocates resources (e.g., time-frequency resources) for communication among some or all devices and equipment within its service area or cell. Within the present disclosure, as discussed further below, the scheduling entity may be responsible for scheduling, assigning, reconfiguring, and releasing resources for one or more scheduled entities. That is, for scheduled communication, UEs or scheduled entities utilize resources allocated by the scheduling entity.

Base stations are not the only entities that may function as scheduling entities. That is, in some examples, a UE may function as a scheduling entity, scheduling resources for one or more scheduled entities (e.g., one or more other UEs). For example, two or more UEs (e.g., UEs 138, 140, and 142) may communicate with each other using sidelink signals 137 without relaying that communication through a base station. In some examples, the UEs 138, 140, and 142 may each function as a scheduling entity or transmitting sidelink device and/or a scheduled entity or a receiving sidelink device to schedule resources and communicate sidelink signals 137 therebetween without relying on scheduling or control information from a base station. In other examples, two or more UEs (e.g., UEs 126 and 128) within the coverage area of a base station (e.g., base station 112) may also communicate sidelink signals 127 over a direct link (sidelink) without conveying that communication through the base station 112. In this example, the base station 112 may allocate resources to the UEs 126 and 128 for sidelink communication. In either case, such sidelink signaling 127 and 137 may be implemented in a peer-to-peer (P2P) network, a device-to-device (D2D) network, a vehicle-to-vehicle (V2V) network, a vehicle-to-everything (V2X) network, a mesh network, or other suitable direct link networks.

In some examples, a D2D relay framework may be included within a cellular network to facilitate relaying of communication to/from the base station 112 via D2D links (e.g., sidelinks 127 or 137). For example, one or more UEs (e.g., UE 128) within the coverage area of the base station 112 may operate as relaying UEs to extend the coverage of the base station 112, improve the transmission reliability to one or more UEs (e.g., UE 126), and/or to allow the base station to recover from a failed UE link due to, for example, blockage or fading.

Two primary technologies that may be used by V2X networks include dedicated short range communication (DSRC) based on IEEE 802.11p standards and cellular V2X based on LTE and/or 5G (New Radio) standards. Various aspects of the present disclosure may relate to New Radio (NR) cellular V2X networks, referred to herein as V2X networks, for simplicity. However, it should be understood that the concepts disclosed herein may not be limited to a particular V2X standard or may be directed to sidelink networks other than V2X networks.

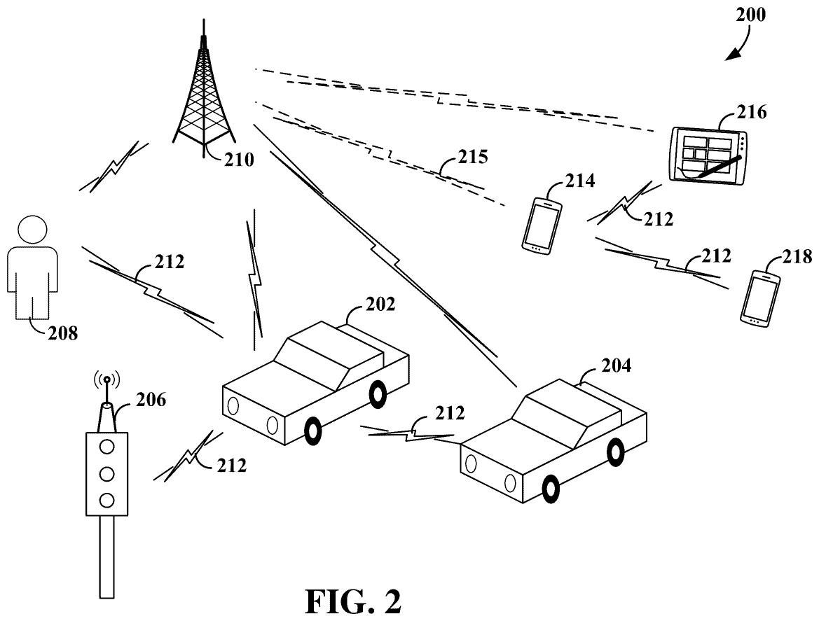

FIG. 2 illustrates an example of a wireless communication network 200 configured to support sidelink communication. In some examples, sidelink communication may include V2X communication. V2X communication involves the wireless exchange of information directly between not only vehicles (e.g., vehicles 202 and 204) themselves, but also directly between vehicles 202, 204 and infrastructure (e.g., roadside units (RSUs) 206), such as streetlights, buildings, traffic cameras, tollbooths or other stationary objects, vehicles 202, 204 and pedestrians 208, and vehicles 202, 204 and wireless communication networks (e.g., network entity 210). The network entity 210 may be, for example, any base station (e.g., gNB, eNB) or other scheduling entity as illustrated in FIG. 1. The network entity 210 may further be implemented in an aggregated or monolithic base station architecture, or in a disaggregated base station architecture. In addition, the network entity 210 may be a stationary network entity or a mobile network entity. In some examples, V2X communication may be implemented in accordance with the New Radio (NR) cellular V2X standard defined by 3GPP, Release 16, or other suitable standard.

V2X communication enables vehicles 202 and 204 to obtain information related to the weather, nearby accidents, road conditions, activities of nearby vehicles and pedestrians, objects nearby the vehicle, and other pertinent information that may be utilized to improve the vehicle driving experience and increase vehicle safety. For example, such V2X data may enable autonomous driving and improve road safety and traffic efficiency. For example, the exchanged V2X data may be utilized by a V2X connected vehicle 202 and 204 to provide in-vehicle collision warnings, road hazard warnings, approaching emergency vehicle warnings, pre-/post-crash warnings and information, emergency brake warnings, traffic jam ahead warnings, lane change warnings, intelligent navigation services, and other similar information. In addition, V2X data received by a V2X connected mobile device of a pedestrian/cyclist 208 may be utilized to trigger a warning sound, vibration, flashing light, etc., in case of imminent danger.

The sidelink communication between vehicle-UEs (V-UEs) 202 and 204 or between a V-UE 202 or 204 and either an RSU 206 or a pedestrian-UE (P-UE) 208 may occur over a sidelink 212 utilizing a proximity service (ProSe) PC5 interface. In various aspects of the disclosure, the PC5 interface may further be utilized to support D2D sidelink 212 communication in other proximity use cases. Examples of other proximity use cases may include public safety or commercial (e.g., entertainment, education, office, medical, and/or interactive) based proximity services. In the example shown in FIG. 2, ProSe communication may further occur between UEs 214, 216, and 218.

ProSe communication may support different operational scenarios, such as in-coverage, out-of-coverage, and partial coverage. Out-of-coverage refers to a scenario in which UEs are outside of the coverage area of a network entity (e.g., network entity 210), but each is still configured for ProSe communication. Partial coverage refers to a scenario in which some of the UEs are outside of the coverage area of the network entity 210, while other UEs are in communication with the network entity 210. In-coverage refers to a scenario in which UEs are in communication with the network entity 210 (e.g., gNB) via a Uu (e.g., cellular interface) connection to receive ProSe service authorization and provisioning information to support ProSe operations.

In some examples, a UE (e.g., UE 218) may not have a Uu connection with the network entity 210. In this example, a D2D relay link (over sidelink 212) may be established between UE 218 and UE 214 to relay communication between the UE 218 and the network entity 210. The relay link may utilize decode and forward (DF) relaying, amplify and forward (AF) relaying, or compress and forward (CF) relaying. For DF relaying, HARQ feedback may be provided from the receiving device to the transmitting device. The sidelink communication over the relay link may be carried, for example, in a licensed frequency domain using radio resources operating according to a 5G NR or NR sidelink (SL) specification and/or in an unlicensed frequency domain, using radio resources operating according to 5G new radio-unlicensed (NR-U) specifications. NR-U operates in the 5 GHz and 6 GHz frequency bands and supports both standalone and licensed-assisted operation based on carrier aggregation and dual connectivity with either NR or LTE in the licensed spectrum. The relay link between UE 214 and UE 218 may be established due to, for example, distance or signal blocking between the network entity 210 and the UE 218, weak receiving capability of the UE 218, low transmission power of the UE 218, limited battery capacity of the UE 218, and/or to improve link diversity. Thus, the relay link may enable communication between the network entity 210 and UE 218 to be relayed via one or more relay UEs (e.g., UE 214) over a Uu wireless communication link 215 and relay link(s) (e.g., sidelink 212 between UE 214 and UE 218). In other examples, a relay link may enable sidelink communication to be relayed between a UE (e.g., UE 218) and another UE (e.g., UE 216) over various relay links (e.g., relay links between UEs 214 and 216 and between UEs 214 and 218).

To facilitate D2D sidelink communication between, for example, UEs 214 and 216 over the sidelink 212, the UEs 214 and 216 may transmit discovery signals therebetween. In some examples, each discovery signal may include a synchronization signal, such as a primary synchronization signal (PSS) and/or a secondary synchronization signal (SSS) that facilitates device discovery and enables synchronization of communication on the sidelink 212. For example, the discovery signal may be utilized by the UE 216 to measure the signal strength and channel status of a potential sidelink (e.g., sidelink 212) with another UE (e.g., UE 214). The UE 216 may utilize the measurement results to select a UE (e.g., UE 214) for sidelink communication or relay communication.

In some examples, a common carrier may be shared between the sidelinks 212 and Uu links, such that resources on the common carrier may be allocated for both sidelink communication between UEs (e.g., UEs 202, 204, 206, 208, 214, 216, and 218) and cellular communication (e.g., uplink and downlink communication) between the UEs (e.g., UEs 202, 204, 206, 208, 214, and 216) and the network entity 210. In 5G NR sidelink, sidelink communication may utilize transmission or reception resource pools. For example, the minimum resource allocation unit in frequency may be a subchannel (e.g., which may include, for example, 10, 15, 20, 25, 50, 75, or 100 consecutive resource blocks) and the minimum resource allocation unit in time may be one slot. The number of subchannels in a resource pool may include between one and twenty-seven subchannels. A radio resource control (RRC) configuration of the resource pools may be either pre-configured (e.g., a factory setting on the UE determined, for example, by sidelink standards or specifications) or configured by a network entity (e.g., network entity 210).

In addition, there may be two main resource allocation modes of operation for sidelink (e.g., PC5) communications. In a first mode, Mode 1, a network entity (e.g., gNB) 210 may allocate resources to sidelink devices (e.g., V2X devices or other sidelink devices) for sidelink communication between the sidelink devices in various manners. For example, the network entity 210 may allocate sidelink resources dynamically (e.g., a dynamic grant) to sidelink devices, in response to requests for sidelink resources from the sidelink devices. For example, the network entity 210 may schedule the sidelink communication via DCI 3_0. In some examples, the network entity 210 may schedule the physical sidelink control channel/physical sidelink shared channel (PSCCH/PSSCH) within uplink resources indicated in DCI 3_0. The network entity 210 may further activate preconfigured sidelink grants (e.g., configured grants) for sidelink communication among the sidelink devices. In some examples, the network entity 210 may activate a configured grant (CG) via RRC signaling. In Mode 1, sidelink feedback may be reported back to the network entity 210 by a transmitting sidelink device.

In a second mode, Mode 2, the sidelink devices may autonomously select sidelink resources for sidelink communication therebetween. In some examples, a transmitting sidelink device may perform resource/channel sensing to select resources (e.g., subchannels) on the sidelink channel that are unoccupied. Signaling on the sidelink is the same between the two modes. Therefore, from a receiver's point of view, there is no difference between the modes.

In some examples, sidelink (e.g., PC5) communication may be scheduled by use of sidelink control information (SCI). SCI may include two SCI stages. Stage 1 sidelink control information (first-stage SCI) may be referred to herein as SCI-1. Stage 2 sidelink control information (second-stage SCI) may be referred to herein as SCI-2.

SCI-1 may be transmitted on a physical sidelink control channel (PSCCH). SCI-1 may include information for resource allocation of a sidelink resource and for decoding the second-stage sidelink control information (i.e., SCI-2). SCI-1 may further identify a priority level (e.g., Quality of Service (QoS)) of a PSSCH. For example, ultra-reliable-low-latency communication (URLLC) traffic may have a higher priority than text message traffic (e.g., short message service (SMS) traffic). SCI-1 may also include a physical sidelink shared channel (PSSCH) resource assignment and a resource reservation period (if enabled). Additionally, SCI-1 may include a PSSCH demodulation reference signal (DMRS) pattern (if more than one pattern is configured). The DMRS may be used by a receiver for radio channel estimation for demodulation of the associated physical channel. As indicated, SCI-1 may also include information about the SCI-2, for example, SCI-1 may disclose the format of the SCI-2. Here, the format indicates the resource size of SCI-2 (e.g., a number of REs that are allotted for SCI-2), a number of a PSSCH DMRS port(s), and a modulation and coding scheme (MCS) index. In some examples, SCI-1 may use two bits to indicate the SCI-2 format. Thus, in this example, four different SCI-2 formats may be supported. SCI-1 may include other information that is useful for establishing and decoding a PSSCH resource.

SCI-2 may be transmitted within the PSSCH and may contain information for decoding the PSSCH. According to some aspects, SCI-2 includes a 16-bit layer 1 (L1) destination identifier (ID), an 8-bit L1 source ID, a hybrid automatic repeat request (HARQ) process ID, a new data indicator (NDI), and a redundancy version (RV). For unicast communications, SCI-2 may further include a CSI report trigger. For groupcast communications, SCI-2 may further include a zone identifier and a maximum communication range for NACK. SCI-2 may include other information that is useful for establishing and decoding a PSSCH resource.

In some examples, the SCI (e.g., SCI-1 and/or SCI-2) may further include a resource assignment of retransmission resources reserved for one or more retransmissions of the sidelink transmission (e.g., the sidelink traffic/data). Thus, the SCI may include a respective PSSCH resource reservation and assignment for one or more retransmissions of the PSSCH. For example, the SCI may include a reservation message indicating the PSSCH resource reservation for the initial sidelink transmission (initial PSSCH) and one or more additional PSSCH resource reservations for one or more retransmissions of the PSSCH.

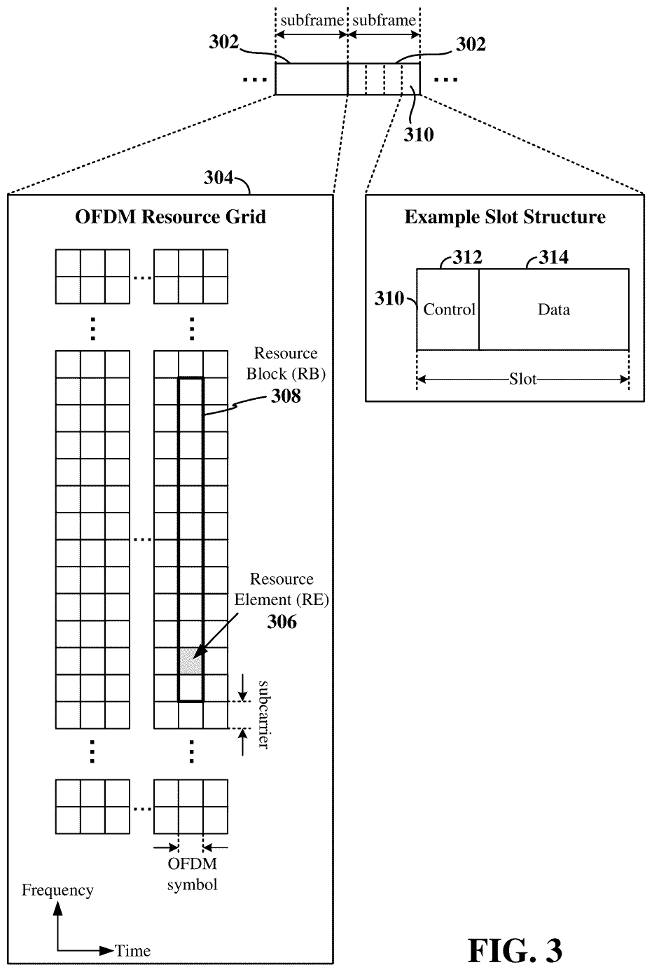

Various aspects of the present disclosure will be described with reference to an OFDM waveform, schematically illustrated in FIG. 3. It should be understood by persons having ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as persons having ordinary sill in the art will readily appreciate, the physical (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain.

A set of continuous or discontinuous resource blocks may be referred to herein as a Resource Block Group (RBG), sub-band, or bandwidth part (BWP). A set of sub-bands or BWPs may span the entire bandwidth. Scheduling of wireless communication devices (e.g., V2X devices, sidelink devices, or other UEs, hereinafter generally referred to as UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB 308 may be the smallest unit of resources that can be allocated to a UE. Thus, the more RBs scheduled for a UE, and the higher the modulation scheme chosen for the air interface, the higher the data rate for the UE. The RBs may be scheduled by a network entity (e.g., gNB, eNB, etc.) or may be self-scheduled by a UE/sidelink device implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded views of slot 310 illustrates that the slot 310 includes a control region 312 and a data region 314. In general, the control region 312 may carry control channels, and the data region 314 may carry data channels. In some examples, a Uu slot (e.g., slot 310) may contain all DL, all UL, or at least one DL portion and at least one UL portion. The structures illustrated in FIG. 3 are merely exemplary in nature, and different slot structures may be utilized, and may include one or more of each of the control region(s) and data region(s).

Although not illustrated in FIG. 3, the various REs 306 within an RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, a slot 310 may be utilized for broadcast, multicast, groupcast, or unicast communication. For example, a broadcast, multicast, or groupcast communication may refer to a point-to-multipoint transmission by one device (e.g., a network entity, UE, or another similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the scheduling entity (e.g., a network entity) may allocate one or more REs 306 (e.g., within the control region 312) of the Uu slot 310 to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgment (ACK) or negative acknowledgment (NACK). HARQ is a technique well-known to persons having ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The network entity may further allocate one or more REs 306 (e.g., in the control region 312 or the data region 314) of the Uu slot 310 to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 30, 40, 80, or 160 ms). An SSB includes a primary synchronization signal (PSS), a secondary synchronization signal (SSS), and a physical broadcast channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information.

In an UL transmission, the scheduled entity (e.g., UE) may utilize one or more REs 306 of the Uu slot 310 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., a request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, a measurement report (e.g., a Layer 1 (L1) measurement report), or any other suitable UCI.

In addition to control information, one or more REs 306 (e.g., within the data region 314) of the Uu slot 310 may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. In some examples, the PDSCH may carry other system information (OSI) including, but not limited to other SIBs, e.g., SIB3 and above.

In an example of sidelink communication over a sidelink carrier via a PC5 interface, the control region 312 of the sidelink slot 310 may include a physical sidelink control channel (PSCCH) including sidelink control information (SCI) (e.g., SCI-1) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, SCI-2 and sidelink MAC-CEs may be transmitted in the data region 314 (the PSSCH) of the slot 310. In addition, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 3 are not necessarily all of the channels or carriers that may be utilized between devices, and persons having ordinary skill in the art will recognize that other channels or carriers may be utilized in addition to those illustrated, such as other traffic, control, and feedback channels.

As indicated above, an apparatus, such as, but not limited to, a hardware implementation of a wireless communication device, a user equipment (UE), a mobile device, a vehicle equipped for 5G NR V2X communication (generally and interchangeably referred to as an apparatus or a UE herein) may operate in Mode 1 or Mode 2 for resource allocation in sidelink. In Mode 1 (scheduled resource allocation), the UE needs to be in an RRC CONNECTED state to transmit data and the NG-RAN schedules transmission resources. In Mode 2 (autonomous resource selection), the UE may transmit data when inside NG-RAN coverage, irrespective of which RRC state the UE is in, and may also transmit data when outside NG-RAN coverage. In Mode 2, the UE autonomously selects transmission resources based on a sensing procedure. The sensing procedure occurs in one or more sidelink resource pools configured by higher layers and provided by broadcast system information or dedicated signaling while the UE is inside NG-RAN coverage or by pre-configuration while the UE is outside NG-RAN coverage. A sidelink resource pool may be used for transmission and reception of PSCCH and PSSCH.

In the frequency domain, a sidelink resource pool includes a number of contiguous subchannels. The size of each subchannel is fixed and each fixed subchannel has N contiguous RBs. Both the number of subchannels and the subchannel size are higher layer pre-configured, by RRC. NR V2X supports N=10, 15, 20, 25, 50, 75, and 100 RBs for possible subchannel sizes. In the time domain, the resources are designated using sidelink bitmaps. Each of the sidelink bitmaps is pre-configured and characterized by a specific size. In Time Division Duplex (TDD), the resources available for sidelink are given by the combination of a TDD pattern and a sidelink bitmap.

For NR V2X unicast and groupcast communication, NR-V2X supports both blind and feedback-based retransmissions. The feedback-based retransmission is facilitated with a physical sidelink feedback channel (PSFCH). Given the feedback provided on the PSFCH, the transmitting SL UE can determine when reception of a packet has failed at the receiving SL UE and can retransmit the failed packet. For broadcast communications, only blind retransmissions are supported. With blind retransmissions, HARQ may be implemented only at the receiver for retransmission combining. The transmitting UE chooses the resources within a resource reservation interval to retransmit. In particular the UE retransmits based on a configured value, which can be up to 31. Blind retransmissions are resource inefficient if the initial transmission is successful. On the other hand, feedback-based retransmissions are more resource efficient because the transmitting UE only retransmits if the original transmission is NACKed. In this case, HARQ is implemented both at the transmitter for efficient retransmissions and at the receiver for retransmission combining. In both cases, NR V2X Mode 2 supports a maximum number of PSSCH transmissions of the same MAC Packet Data Unit (PDU), which is pre-configured and whose maximum value is equal to 32. Even if feedback-based retransmissions are more resource efficient, blind retransmissions allow to minimize the latency of the feedback-based retransmissions, as the transmitting UE does not need to wait for a HARQ feedback before sending a retransmission.

NR V2X supports time multiplexing of the PSCCH, PSSCH, and PSFCH. For example, the PSCCH may be transmitted first, utilizing two or three symbols at the start of the symbols available for sidelink transmission in a slot. The PSSCH follows in the remaining symbols of the slot. Every 1, 2, or 4 slots available for sidelink, the PSCCH and PSSCH are multiplexed with the PSFCH. The PSFCH may occupy the last two symbols configured for sidelink, excluding guard period symbols. In the frequency domain, the PSSCH can occupy up to the maximum number of available subchannels for sidelink, depending on the amount of data to transmit. However, the PSCCH spans over a pre-configured number of consecutive RBs (i.e., K RBs) in the first subchannel in which PSSCH is transmitted, where K≤N RBs and Nis the subchannel size. NR V2X supports K=10, 12, 15, 20, and 25. Finally, the candidate resources (i.e., RBs) for PSFCH are determined as per the PSSCH transmission(s) for which the feedback is generated.

As described above, resource reservation for NR V2X Mode 2 may employ a sensing procedure. During the sensing procedure, the UE senses, by receiving, SCI-1(s) from neighbor user equipment(s) (e.g., adjacent UEs, nearby UEs, UEs with transmissions that are powerful enough to be received by the sensing UE without regard to the physical proximity of the neighbor user equipment) during a sensing window, decodes the SCI-1(s), and filters out slots that will be used by the neighbor user equipment(s) in a resource selection window. The UE may determine the slots that will be used by the neighbor user equipment(s) from the information in the decoded SCI-1(s).

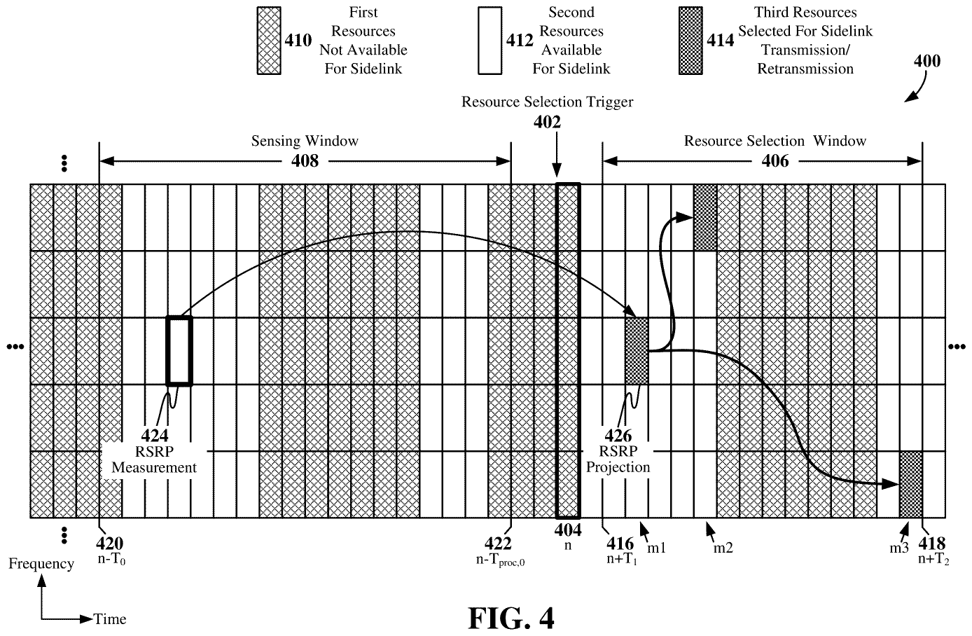

FIG. 4 is an illustration of a portion of a resource grid (e.g., a time-frequency resource grid, an OFDM resource grid) (hereinafter referred to as resource grid 400) associated with an example of a 5G New Radio (NR) vehicle to everything (V2X) sidelink Mode 2 resource reservation process according to some aspects of the disclosure. The resource grid 400 may be similar to the resource grid 304 as shown and described in connection with FIG. 3. The resource grid 400 includes five subchannels in the frequency domain and forty slots in the time domain and is provided for exemplary and non-limiting purposes.

In general, in NR V2X sidelink processes, a resource selection window 406 and a sensing window 408 may be configured. Within both windows there may be first resources 410 not available for sidelink communication (e.g., because they are configured for cellular communication via a Uu interface) and second resources 412 that are available for sidelink communication (e.g., because they are members of a sidelink resource pool and configured for sidelink communication via a PC5 interface). A sidelink UE (not shown) (referred to herein for the sake of brevity as a UE) may obtain RSRP measurements of the second resources 412, such as the RSRP measurement 424 associated with an SCI-1 of the second resource 412 illustrated with a bold border to identify its location in this example. The UE may project the RSRP measurement 424 obtained during the sensing window 408 onto one or more reservations of one or more resources (e.g., such as the RSRP projection 426) in the resource selection window 406. The UE may compare each RSRP obtained in the sensing window 408 with an RSRP threshold (Thr_RSRP) and increase the threshold by y dB (where, for example, y may be 3 or 6 dB) after each comparison until a configurable percentage, x %, of resources measured have RSRP values below the RSRP threshold.

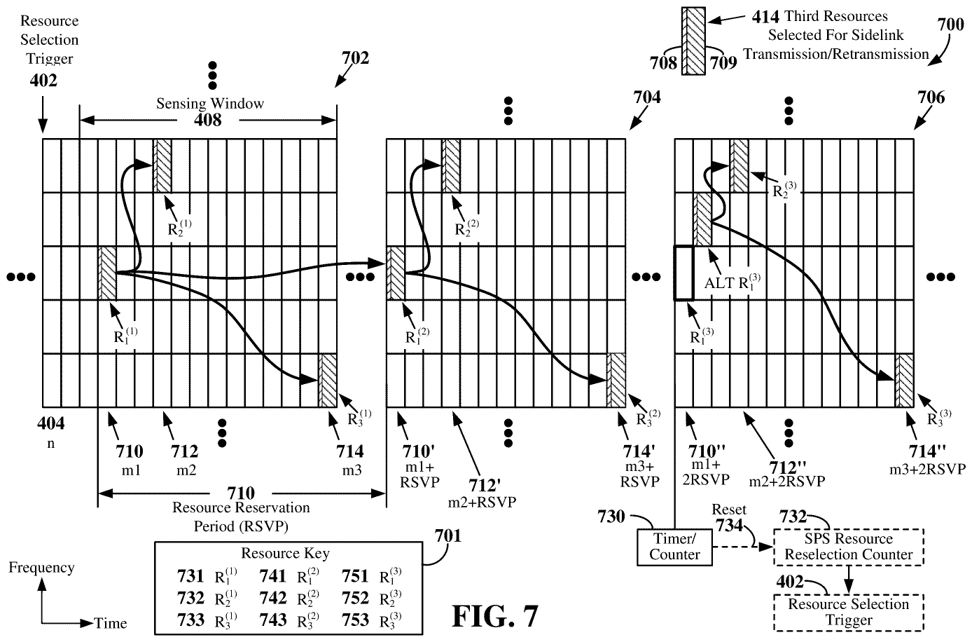

A UE may autonomously select its sidelink resources (one or several subchannels in one or several slots) from a resource pool when using Mode 2 in NR V2X. Resource selection in Mode 2 may operate using a dynamic or a semi-persistent scheduling (SPS) scheme. A dynamic scheme may select resources for one transmission of a transport block (TB) while an SPS scheme may select resources for a number of consecutive transmissions (i.e., a first transmission and one or more retransmissions) of the TB. The total number of transmissions and retransmissions is sometimes counted using a counter referred to as an SPS Resource Reselection Counter (e.g., 732, FIG. 7) according to some aspects of the disclosure. In some examples, the total number may be randomly chosen each time new resources are selected. A Resource Reservation Interval (RRI), also referred to herein as a resource reservation period (RSVP), both in units of ms, may be indicated in a first-stage SCI (an SCI-1) transmitted by the UE, so that neighbor user equipments may be aware of (and may determine by decoding the SCI-1) the resources reserved by the UE for a transmission of a current TB (i.e., the TB transmitted in the same slot as the SCI-1) and resources reserved for retransmissions of the TB.

As indicated, a counter referred to as an SPS Resource Reselection Counter may count the number of times a TB has been transmitted and retransmitted. The counting may be in a downward manner, for instance, at the outset, it may be known that a given number represents the quantity of all desired transmissions (including an initial transmission and all retransmissions) of a given TB. The SPS Resource Reselection C may be initialized to this given number and decreased each time a transmission/retransmission of the given TB occurs. In such an example, the UE may trigger an SPS resource reselection and select new resources upon the UE evaluating, with probability (1−P), where Pϵ[0, 0.8], whether the UE must select new resources for a next TB, when the SPS Resource Reselection Counter (sometimes called a Resource Counter) decrements to 0; otherwise, the UE may continue using the same sidelink resources for another given number of consecutive TBs as counted by the SPS Resource Reselection Counter. In some examples, if the UE determines to select new resources for the next TB, the UE may set the resource reservation interval (RRI) to 0 ms in the SCI-1, which may indicate to other UEs that the UE is not reserving the same resources (i.e., all of the same previously reserved resources) for retransmissions of the TB. Note that in contradistinction, according to aspects described herein, the RSVP may be set to 0 ms to indicate that the current TB will not be repeated in a corresponding resource in a next SPS process (i.e., transmission of the TB will not be repeated with the periodicity used to retransmit the same TB in association with other resources); however, the TB may be retransmitted on other resources in the same SPS process using a different RSVP (e.g., a non-zero RSVP) defined in the SCI-1 associated with at least one of the other resources.

The UE may also trigger an SPS resource reselection and select new resources if the previously reserved resources are not sufficient to fit the traffic volume of a new TB scheduled for transmission, or if the previously reserved resources cannot meet the latency requirement for the new TB. The resource selection trigger 402 may be associated with a slot (referred to as slot n 404 herein). The slot n 404 may be a slot relative to which at least the resource selection window 406 and the sensing window 408 are defined (in connection with a semi-persistent scheduling resource reservation/selection process).

Upon obtaining the resource selection trigger 402 at slot n 404, the UE may establish the resource selection window 406. The UE will select sidelink resources from among the resources available for sidelink communication within the resource selection window 406. The selected resources may be used to transmit the TB, or portion of a pending TB, that requires resources in addition to those already scheduled via a prior SPS process.

Not all of the resources in the resource selection window are available for sidelink communication. For example, the first resources 410 may be utilized with a Uu reference point for non-sidelink communications; accordingly, first resources 410 are not available for sidelink. The exemplary resource grid 400 is provided for reference and is not intended to be limiting. Additionally, although the remaining resources in the resource selection window (i.e., the second resources 412 and the third resources 414) may be available for sidelink communication, not all of those resources will be selected by the UE as resources to carry a sidelink initial transmission and one or more retransmissions according to an SPS process. Of the remaining resources, the third resources 414 may be selected for sidelink transmission/retransmission, in accordance with a resource allocation/resource selection process according to aspects herein.

As stated, in response to receiving a resource selection trigger 402 at slot n 404, the UE may establish the resource selection window 406. The resource selection window spans the time domain between and including slots (n+T₁) 416 and (n+T₂) 418. According to some aspects, T₁ may be the processing time (in slots) required by the UE to identify candidate resources and select new sidelink resources for transmission. T₁ is equal to or smaller than T_{proc,1}, where T_{proc,1} is equal to 3, 5, 9 or 17 slots for a subcarrier spacing (SCS) of 15, 30, 60, or 120 kHz, respectively. T₂ may be determined according to UE implementation, and should fall within the limits of T_{2,min}≤T₂≤(remaining) Packet Delay Budget (in slots). The Packet Delay Budget is a latency deadline by which the TB must be transmitted. The deadline is established by the V2X application generating the packet to be transmitted in the TB. T₂ₘᵢₙ may be dependent upon the priority associated with the TB and the SCS.

Subsequent to definition of the resource selection window 406, the UE may identify candidate resources within the resource selection window 406. A candidate resource may be identified by a given slot in the time domain and a quantity of PSSCH contiguous subchannels in the frequency domain. The quantity of PSSCH contiguous subchannels may be referred to as L_{PSSCH}, which may range from 1≤L_{PSSCH}≤max(L_{PSSCH}). The value of max(L_{PSSCH}) corresponds to a total number of subchannels per slot in the resource selection window 406, but may be modified based on congestion. According to some aspects, a TB and its associated SCI (i.e., SCI-1 in PSCCHs and SCI-2 in PSSCHs) fit within the total number of slots available for sidelink communication multiplied by the selected L_{PSSCH}. In the example of FIG. 4, L_{PSSCH} is equal to 1 for ease of illustration and not limitation.

The UE senses the sidelink resources within the sensing window 408 unless the UE is transmitting utilizing the sidelink resource within the sensing window 408. The UE senses the sidelink resources in the sensing window 408 to identify candidate resources in the resource selection window 406. The sensing window 408 falls within the range of slots that is greater than or equal to n−T₀ 420 and less than n−T_{proc,0} 422, where n is slot n 404, T₀ is an integer number of slots that depends on SCS. T₀ may be configured. T_{proc,0} is the time the UE requires to complete the sensing procedure and is equal to one slot for an SCS of 15 or 30 kHz, and equal to 2 or 4 slots for an SCS of 60 or 120 kHz, respectively.

While sensing the sidelink resources in the sensing window 408, the UE decodes each SCI-1 received from neighbor user equipment that had transmitted respective SCI-1s in the sidelink resources within the sensing window 408. From each decoded SCI-1 of a neighbor user equipment, the sensing UE may obtain an indication of priority, a frequency resource assignment and time resource assignment for transmission/retransmission of the neighbor user equipment's TB associated with the neighbor user equipment's decoded SCI-1, a resource reservation period (RSVP) for the retransmissions of the neighbor user equipment's TB, a DMRS pattern, an SCI-2 format, a modulation and coding scheme (MCS), a beta-offset indicator, and the number of DMRS ports. In this way, the sensing UE may identify sidelink resources in the resource selection window 406 that are reserved by each respective neighbor user equipment associated with the neighbor user equipment's respective SCI-1.

Additionally, the sensing UE measures the respective RSRP associated with each respective received neighbor user equipment SCI-1 and stores the obtained information (e.g., the respective decoded SCI-1 information and associated RSRP measurement corresponding to the decoded SCI-1 of each respective neighbor user equipment) and uses the stored information to exclude candidate sidelink resources in the sensing window 408 that will be occupied when the resource selection trigger 402 at slot n 404 is processed (by at least one of two or more processors at the sensing UE). In greater detail, the sensing UE may exclude the candidate sidelink resource if the RSRP, associated with the SCI-1 that includes the reservation of the candidate sidelink resource, is higher than an RSRP threshold that is configured or preconfigured in the sidelink resource pool. The RSRP threshold may depend on the priority of the TB to be carried by the candidate resources being selected by the sensing UE, and may depend on the priority (included in the SCI-1) of the other UE that reserved the resource.

Once all of the candidate sidelink resources reserved by the neighbor user equipments have been excluded, the sensing UE determines if the percentage of remaining available candidate sidelink resources, in the resource selection window 406, is equal to or greater than a configured percentage. The value of the configured percentage may be 20, 35, or 50 percent in some examples. If the percentage is not equal to or greater than the configured percentage, too many candidate sidelink resources were excluded. As exclusion requires that the RSRP associated with a given SCI-1 be greater than a threshold RSRP value, the threshold RSRP value may be increased by 3 dB (i.e., the received threshold power is doubled). Raising the RSRP threshold by 3 dB will result in some of the previously excluded resources being included (not excluded) in the set of available sidelink resources. That is, a respective RSRP associated with an SCI-1 of a neighbor user equipment that was previously too high (greater than the original RSRP threshold) will now be lower than the raised RSRP threshold (meaning that the power received in the candidate resource is less than the raised threshold and presumably will not interfere with (collide with) the transmission/retransmission of a TB from the sensing UE). Removing the exclusion of the previously excluded candidate sidelink resource increased the number of available sidelink resources. Once the number of available sidelink resources is equal to or greater than the configured percentage, the process of increasing the RSRP threshold may stop and selection of candidate sidelink resources may proceed. The sensing UE may then randomly select N candidate resources from among the available non-excluded resources in the resource selection window 406 for N total transmissions of a TB, where the N total transmissions include an initial transmission of the TB and the N−1 blind or potential HARQ retransmissions of the TB. In some examples N≤N_{MAX} and 1≤N_{MAX}≤32.

In the example of FIG. 4, a first of three (N=3) transmissions of a TB occurs in a first slot m1, three slots after slot n 404. A first retransmission of the TB occurs three slots later, in slot m2, and a second retransmission of the TB occurs nine slots later, in slot m3.

An SCI-1 (not shown) included in the PSCCH (not shown) associated with the first transmission of the TB in the indicated resource in the first slot, m1, signals the first resource reservation for the first transmission of the TB transmitted in the PSSCH of the same slot (m1) as the transmission of the SCI-1, the second resource reservation (see upper arrow) for the first repetition of the TB in the second slot, m2, and the second repetition of the TB in the third slot m3. However, an SCI-1 may be limited to notifications of resource reservations within 32 slots of the first slot (m1) including the SCI-1. For ease of illustration and purposes of brevity and not limitation, the examples described herein may all be understood to relate to a first SCI-1 making resource reservations within 32 slots of the first slot (m1) including the first SCI-1.

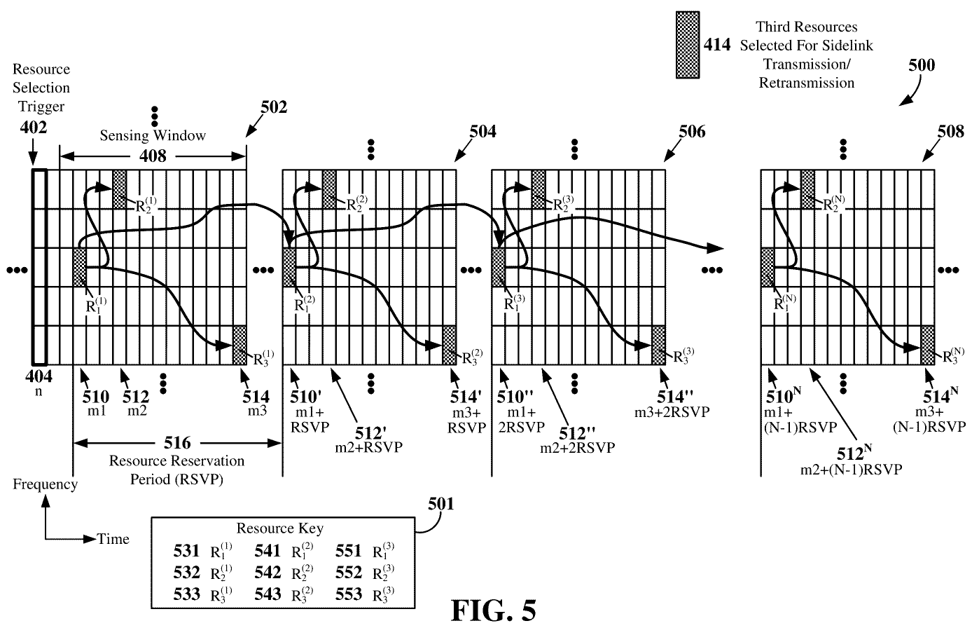

FIG. 5 is an illustration depicting four (N=4) SPS processes 502, 504, 506, 508 according to some aspects of the disclosure. The four SPS processes 502, 504, 506, 508 are depicted in respective portions of a resource grid 500, where the first SPS process 502, including slot n 404 and fifteen slots following slot n 404, was also depicted in a portion of the resource grid 400 of FIG. 4 according to aspects herein. To avoid cluttering the drawing, the cross-hatching that indicated the first resources 410 not available for sidelink has been removed. In FIG. 5, the vertical axis is in units of subchannels, and the horizontal axis is in units of slots.

In general, an SPS reservation in an SCI-1 reserves N resources for the initial and retransmission(s) of a current TB (a TB in the same slot as the SCI-1) and indicates the period (RSVP or RRI) of repetition so that the same N resources (i.e., time-frequency resources) that are presently reserved by the SPS reservation are also reserved RSVP ms later. The resources referred to in connection with FIG. 5 are identified using the nomenclature

$${R}_{i}^{( j )} ,$$

where the identified resource, R, is reserved for the ith transmission in the j^{th} SPS process. A resource key 501 is provided in FIG. 5 to cross reference each resource to a figure reference number. Accordingly, the first slot m1 510 includes the first resource

$${R}_{1}^{( 1 )} 531$$

in the first SPS process 502. The second slot m2 512 includes the second resource

$${R}_{2}^{( 1 )} 532$$

in the first SPS process 502. The third slot m3 514 includes the third resource

$${R}_{3}^{( 1 )} 533$$

in the first SPS process 502.

As indicated above, the UE may signal the reservations of the first, second, and third resources

$${R}_{1}^{( 1 )} 531 , {R}_{2}^{( 1 )} 532 , and {R}_{3}^{( 1 )} 533 ,$$

respectively in the first SCI-1 (not shown) of the PSCCH (not shown) conveyed in the first resource

$${R}_{1}^{( 1 )} 531.$$

In FIG. 5, the indications of resource reservations are represented by arrows exiting the first resource

$${R}_{1}^{( 1 )} 531$$

and terminating in the second resource

$${R}_{2}^{( 1 )} 532$$

and the third resource

$${R}_{3}^{( 1 )} 533$$

of the first SPS process 502, respectively. The arrow exiting the first resource

$${R}_{1}^{( 1 )} 531$$

and terminating on the first resource

$${R}_{1}^{( 2 )} 541$$

of the second SPS process 504 represents the presentation of the resource reservation period (hereinafter RSVP 516) in the SCI-1 associated with the first resource

$${R}_{1}^{( 1 )} 531$$

in the first slot m1 510. Using the RSVP 516, the UE informs other UEs decoding the UE's transmission, in the first resource

$${R}_{1}^{( 1 )} 531$$

of the first SPS process 502, of the repeated reservations in the second SPS process 504, the third SPS process 506, and through to the Nth SPS process 508.

That is, the first resource

$${R}_{1}^{( 2 )} 541$$

of the second SPS process 504 occurs at the m1+RSVP slot 510′. The second resource

$${R}_{2}^{( 2 )} 542$$

of the second SPS process 504 occurs at the m2+RSVP slot 512′. The third resource

$${R}_{3}^{( 2 )} 543$$

of the second SPS process 504 occurs at the m3+RSVP slot 514′.

The first resource

$${R}_{1}^{( 3 )} 551$$

in the third SPS process 506 occurs at the m1+2RSVP slot 510″. The second resource

$${R}_{2}^{( 3 )} 552$$

in the third SPS process 506 occurs at the m2+2RSVP slot 512″. The third resource

$${R}_{3}^{( 3 )} 553$$

in the third SPS process 506 occurs at the m3+2RSVP slot 514″.

The first resource

$${R}_{1}^{( N )}$$

of the N^{th} SPS process 508 occurs at the m1+(N−1)RSVP slot 510^{N}. The second resource

$${R}_{2}^{( N )}$$

of the N^{th} SPS process 508 occurs at the m2+(N−1)RSVP slot 512^{N}. The third resource

$${R}_{3}^{( N )}$$

of the N^{th} SPS process 508 occurs at the m3+(N−1)RSVP slot 514^{N}.

Ac cordingly, the SPS scheme reserves the same resources for periodic applications (transmission and retransmission(s) of a TB) within the count monitored by an SPS Resource Reselection Counter. As shown in FIG. 5, the first transmission of the first SPS process 502 (in a first SCI-1 in the first resource

$${R}_{1}^{( 1 )} 531 )$$

in the first SPS process 502 reserves (and signals the reservations of) itself and the repetitions of the two additional resources in the second SPS process 504. The same process continues until resource reselection is triggered.
However, the first transmission (in the first resource

$${R}_{1}^{( 1 )} 531 )$$

of the RSVP may collide with a transmission from a neighbor user equipment, and the UE may not recognize the collision. Other UEs (e.g., neighbor user equipments) may detect potential resource collisions for subsequent transmissions. Still, the initial transmission of the first period (i.e., the RSVP) may collide with another UE's reservation, where the another UE may have triggered resource (re) selection at the same time as the UE.

By way of example, the UE may fail to detect an interferer at resource selection time due to half-duplex operation of the UE, hidden node issues, or other issues. For example, due to mobility, UEs, with relative motion toward the UE and using overlapping resources with the UE, which were at a first distance at a first time (where their overlapping transmissions were attenuated by the first distance and did not interfere with the UE) may have, due to their mobility, reduced the first distance at a second time (where their overlapping transmissions are less attenuated) may become an interferer.

According to periodic nature of the SPS reservation process as described, once a collision happens, the collision keeps happening (repeats itself) in all following periods. Accordingly, aspects described herein may avoid an initial transmission collision and propose resource reselection processes that may prevent unnecessary reselections of resources and may reduce interference.

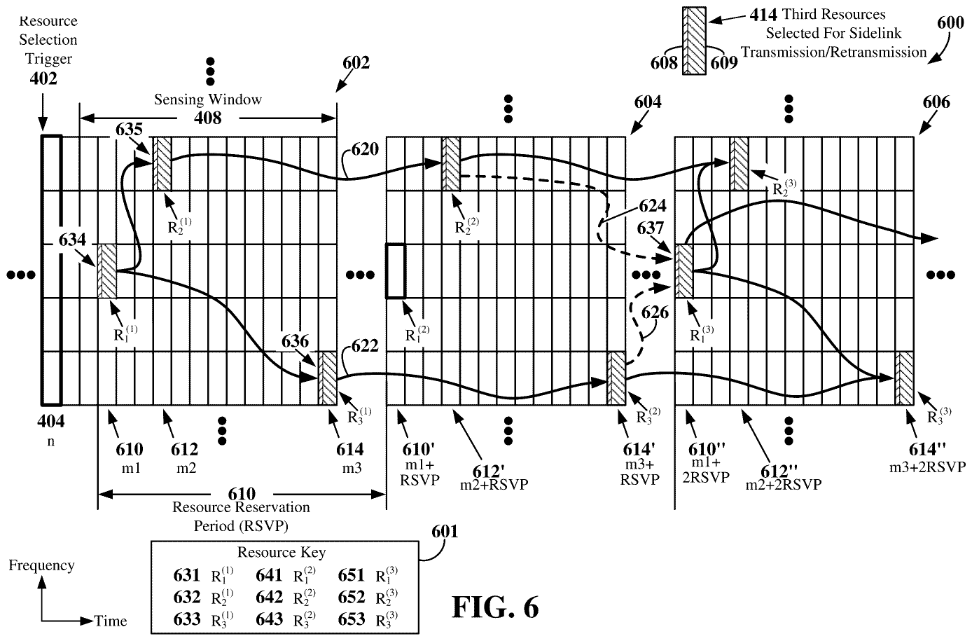

FIG. 6 is an illustration depicting three (N=3) SPS processes 602, 604, 606 according to some aspects of the disclosure. The three SPS processes 602, 604, 606 are depicted in respective portions of a resource grid 600, where the first SPS process 602, including slot n 404 and fifteen slots following slot n 404, was also depicted in a portion of the resource grid 400 of FIG. 4 according to aspects herein. To avoid cluttering the drawing, the cross-hatching that indicated the first resources 410 were not available for sidelink has been removed. In FIG. 6, the vertical axis is in units of subchannels, and the horizontal axis is in units of slots. The resources identified using the nomenclature R in FIG. 7 include the third resources 414 selected for transmission/retransmission; the pattern associated with the third resources 414 in FIGS. 4 and 5 has been replaced with respective patterns representative of a PSCCH 608 and a PSSCH 609, respectively. A resource key 601 is provided in FIG. 6 to cross reference each resource to a figure reference number.

According to some examples, a UE transmitting in the resources illustrated in FIG. 6 may omit (e.g., abstain from including, not include) an RSVP in a first SCI-1 634 in a PSCCH 608 associated with the first transmission of a TB (e.g., data) in the first resource

$${R}_{1}^{( 1 )} 631$$

of the first SPS process 602 in the first slot m1 610. Alternatively, the UE may include an RSVP having an RSVP value that is indicative of no semi-persistent scheduling of the TB (e.g., the data).

In contrast, the UE may include the RSVP in one or both respective SCI-1s 635, 636 in respective PSCCHs 608 associated with the retransmissions of the TB in the second resource

$${R}_{2}^{( 1 )} 632$$

(in the second slot m2 612) and/or the third resource

$${R}_{3}^{( 1 )} 633$$

(in the third slot m3 614) of the first SPS process 602. As a result, the first resource

$${R}_{1}^{( 1 )} 631$$

in the first SPS process 602 may carry the transmission of the TB, while the first resource

$${R}_{1}^{( 2 )} 641$$

in the second SPS process 604 (in the first slot m1+RSVP 610′ of the second SPS process 604) may not carry a retransmission of the TB (in the second SPS process 604).

In the example, the first resource

$${R}_{1}^{( 2 )} 641$$

in the second SPS process 604 may be used for sensing, by receiving in the first resource

$${R}_{1}^{( 2 )} 641$$

(also referred to as receiving in a following resource of the second SPS process 604) a third SCI-1 transmitted by a neighbor user equipment, the following resource (i.e.,

$${R}_{1}^{( 2 )} 641 )$$

corresponding to the first resource (i.e.,

$${R}_{1}^{( 1 )} 631 )$$

shifted in time by the second RSVP. As used herein, sensing may include receiving a signal (e.g., receiving information (e.g., an SCI-1)) and measuring an RSRP associated with the received signal (e.g., measuring an RSRP associated with the received SCI-1) (if any signal is receivable in the given resource).

At least one reason to omit including an RSVP from the first SCI-1 634 associated with the first resource

$${R}_{1}^{( 1 )} 631$$

(or including the RSVP but setting the RSVP value to a preconfigured value indicative of an absence of a retransmission of the current TB included in the first resource

$${R}_{1}^{( 1 )} 631 )$$

may be to avoid a transmission collision with a transmission from a neighbor user equipment that may be transmitting in the first resource

$${R}_{1}^{( 2 )} 641$$

of the second SPS process 604 (and/or periodically transmitting in each of the first resources

$${R}_{1}^{( 1 )} 631 , {R}_{1}^{( 2 )} 641 , and {R}_{1}^{( 3 )} 651$$

of the first SPS process 602, the second SPS process 604, and the third SPS process 606, respectively). Rather than transmitting in the first resource

$${R}_{1}^{( 2 )} 641$$

of the second SPS process 604, the UE may receive in the first resource

$${R}_{1}^{( 2 )} 641$$

(i.e., sense the first resource for another UE's transmission(s) of SCI-1(s)).

Returning for another example with reference to FIG. 6, a UE may transmit, in the first SCI-1 634 of the first SPS process 602, the location, e.g., the time-frequency location in the resource grid 600, of the first resource

$${R}_{1}^{( 1 )} 631 ,$$

the second resource

$${R}_{2}^{( 1 )} 632 ,$$

and the third resource

$${R}_{3}^{( 1 )} 633 ,$$

as well as an RSVP when transmitting the TB in the first resource

$${R}_{3}^{( 2 )} 643$$

As a consequence, three additional resources,

$${R}_{1}^{( 2 )} 641 , {R}_{2}^{( 2 )} 642 ,$$

and

$${R}_{1}^{( 1 )} 631.$$

in the following SPS process, the second SPS process 604, would be reserved.

However, according to aspects described herein, the UE may transmit in a first resource

$${R}_{1}^{( 1 )} 631 ,$$

a first first-stage-sidelink control information (first SCI-1 634) and data (e.g., a TB), the first SCI-1 634 including a first resource reservation information reserving the first resource

$${R}_{1}^{( 1 )} 631$$

in a first semi-persistent scheduling (SPS) process 602 and omitting (e.g., abstaining from including, not including) a first resource reservation period (RSVP). In addition, the UE may transmit in at least one subsequent resource (e.g., 632 or (632 and 633)), a second first-stage-sidelink control information (second SCI-1) (e.g., 635 or (635 and 636)) and the data, the second SCI-1 635, 636 including a second resource reservation information reserving the at least one subsequent resource in the first SPS process 602 and comprising a second RSVP having a second RSVP value greater than zero (or any value greater than zero except any predetermined valued indicative of an absence of a semi-persistent scheduling of the data) and indicative of a semi-persistent scheduling of the data.

The inclusion of the second RSVP value in the second resource

$${R}_{2}^{( 1 )} 632$$

is noted by the presence of the arrow 620 joining the second resource

$${R}_{2}^{( 1 )} 632$$

in the first SPS process 602 in the second resource

$${R}_{2}^{( 2 )} 642$$

in the second SPS process 604 (where the two resources are separated in time by the second RSVP value). Similarly, the inclusion of the second RSVP value in the third resource

$${R}_{3}^{( 1 )} 633$$

is noted by the presence of the arrow 622 joining the third resource

$${R}_{3}^{( 1 )} 633$$

in the first SPS process 602 to the third resource

$${R}_{3}^{( 2 )} 643$$

in the second SPS process 604 (where the two resources are separated in time by the second RSVP value).

According to some aspects, in lieu of omitting the first RSVP, the UE may include the first RSVP in the first SCI-1 (634), where the first RSVP is a predetermined value indicative of an absence of a repetition of the data in a subsequent first resource 641 in a second SPS process 604, the subsequent first resource 641 separated in time from the first resource 631 by the second RSVP value. In some examples, the predetermined value is zero.

The UE may also sense, by receiving in a following resource 641 in a second SPS process 604 (i.e., the first resource

$${R}_{1}^{( 2 )} 641 ) ,$$

a third SCI-1 (not shown) transmitted by a neighbor user equipment (not shown), the following resource 641 corresponding to the first resource 631 (i.e., the first resource

$${R}_{1}^{( 1 )} 631 )$$

shifted in time by the second RSVP.

The UE may also transmit in a first resource (651) in the third SPS process (606) (i.e., the first resource

$${R}_{1}^{( 3 )} 651 )$$

a fourth first-stage-sidelink control information (fourth SCI-1) 637 and the data (in the PSSCH 609), the fourth SCI-1 637 including a next resource reservation information reserving at least the first resource (651) in the third SPS process (606) and comprising the second RSVP, the first resource (651) in the third SPS process (606) corresponding to the first resource 631 of the first SPS process (602) (i.e., the first resource

$${R}_{1}^{( 1 )} 631 )$$

shifted in time by twice the second RSVP, the transmitting in response to a reference signal power (RSRP) associated with the third SCI-1 being less than a reselection triggering threshold. In some examples, the reselection triggering threshold may be a function of a channel busy ratio (CBR). In some examples, the reselection triggering threshold is set equal to an RSRP threshold plus a gap value of 3 dB or 6 dB.

It is noted that the UE could elect to signal, in the third SPS process 606, the location, e.g., the time-frequency location in the resource grid 600, of

$${R}_{1}^{( 3 )} 651 , {R}_{2}^{( 3 )} 652 , and {R}_{3}^{( 3 )} 653$$

as well as the same or a different RSVP as the RSVP indicated as being conveyed by arrows 620 and/or 622, when transmitting the data in the first

$${R}_{1}^{( 3 )} 651$$

in the third SPS process 606. The UE might do this if it determined that no collision would have occurred in the first resource

$${R}_{1}^{( 2 )} 641$$

of the second SPS process 604. As a consequence, three additional resources

$${R}_{1}^{( 4 )} , {R}_{2}^{( 4 )} , and {R}_{3}^{( 4 )}$$

(not shown) in a fourth SPS process (not shown) would be reserved.

The UE may alternatively elect to signal, in the second SPS process 604, in the SCI-1 of the second resource

$${R}_{2}^{( 2 )} 642$$

(in the second slot m2+RSVP 612′) and/or in the SCI-1 of the third resource

$${R}_{3}^{( 2 )} 643$$

(in the third slot m3+RSVP 614′), the location, e.g., the time-frequency location in the resource grid 600, of the first resource

$${R}_{1}^{( 3 )} 651$$

in the third SPS process 606 as well as the same or a different RSVP as the RSVP indicated as being conveyed by arrows 620 and/or 622, when transmitting the data in the second resource

$${R}_{2}^{( 2 )} 642$$

and/or the third resource

$${R}_{3}^{( 2 )} 643$$

both in the second SPS process 604. Such potential signaling is represented by the first dashed arrow 624 between the second resource

$${R}_{2}^{( 2 )} 642$$

in the second SPS process 604 and the first resource

$${R}_{1}^{( 3 )} 651$$

in the third SPS process 606 and/or the second dashed arrow 626 between the third resource

$${R}_{3}^{( 2 )} 643$$

in the second SPS process 604 and the first resource

$${R}_{1}^{( 3 )} 651$$

in the third SPS process 606.

According to some aspects described herein, and as described and illustrated in connection with the example of FIG. 6, to avoid continuous collisions with transmissions from a neighbor user equipment on a given resource, the UE may change (e.g., perturb, influence in order to alter a normal or regular aspect of a process) an SPS resource allocation process such that the UE is able to receive on the given resource (i.e., receive in order to detect a presence of an interfering transmission on the given resource), to avoid a collision on the given resource that otherwise (without the change) would have occurred when the UE (in the otherwise regular practice of an SPS process, for example) would have transmitted on the given resource. The aspects described herein may be beneficial in all aspects of 5G NR V2X (sidelink) communication and may have enhanced benefits for medium or higher system load scenarios.

According to some aspects described herein, a UE may change (e.g., perturb, influence in order to alter a customary or regular aspect of a process) SPS resources or an SPS resource allocation process for certain transmission(s) at various (e.g., random or preconfigured) times. For example, as described in connection with FIG. 6, a UE may not signal an RSVP for the first transmission of a given SPS process (e.g., an SPS period), so the first transmission on the following SPS process may be skipped, which may allow the UE to sense (e.g., receive, listen, measure) on a slot (or on one or more subchannels of the slot that that include resources available for sidelink transmission and retransmission) during the time that the UE would otherwise be transmitting. The UE may then detect transmission(s) of, for example, reservation signal(s) from other UE(s) (e.g., neighbor user equipment(s)) that transmit the reservation signal(s) to reserve the same resource(s) as the sensing UE and provide the sensing UE with an opportunity to reselect resource(s) to avoid periodic collisions.

In another example, a UE may skip transmitting on at least one SPS resource of a given SPS process, and transmit on at least one other another, randomly selected SPS resource (i.e., mute and listen) in the given SPS process. In another example, the UE may skip some SPS resource(s) for one SPS process and may optionally select replacement SPS resource(s) for some or all of the skipped SPS resource(s).

FIG. 7 is an illustration depicting three (N=3) SPS processes 702, 704, 706 according to some aspects of the disclosure. The three SPS processes 702, 704, 706 are depicted in respective portions of a resource grid 700, where the first SPS process 702, including slot n 404 and fifteen slots following slot n 404, was also depicted in a portion of the resource grid 400 of FIG. 4 according to aspects herein. To avoid cluttering the drawing, the cross-hatching that indicated the first resources 410 not available for sidelink has been removed. In FIG. 7, the vertical axis is in units of subchannels and the horizontal axis is in units of slots. The resources identified using the nomenclature

$${R}_{i}^{( j )}$$

in FIG. 7 include the third resources 414 selected for transmission/retransmission; the pattern associated with the third resources 414 in FIGS. 4 and 5 has been replaced with respective patterns representative of a PSCCH 708 and a PSSCH 709, respectively. A resource key 701 is provided in FIG. 7 to cross reference each resource to a figure reference number.

According to some examples, a UE (not shown) may change SPS resources for certain transmission(s) in a given period, at a given time, or upon reaching a value (e.g., zero or a predefined value greater than zero) in connection with a use of a counter. The given period, given time, the value of the counter reached if incrementing the counter, or a value given to initiate a counter if decrementing the counter, may be random or predetermined. According to some examples, a timer/counter 730 may be defined to trigger periodic changes to SPS processes, resources, SPS resource allocation aspects, and/or SPS resource reselection aspects according to some aspects of the disclosure.

For example, a UE may use the timer/counter 730 to measure a period of time (e.g., x seconds). The value of x may be predetermined or randomly selected. At expiration of the period of time (if counting down), or upon reaching the period of time (if counting up), the UE may change at least one aspect of one or more SPS processes, such as the first SPS process 702, the second SPS process 704, and/or the third SPS process 706. For example, the change to the at least one SPS process 702, 704, 706 may be triggered if a same resource (e.g., the first resource

$${R}_{1}^{( 1 )} 731 and {R}_{1}^{( 2 )} 741 )$$

has been used for respective transmissions/retransmissions for x seconds. In the example of FIG. 7, x may be twice the RSVP. As shown in the example, the change that occurs when the timer/counter reaches x seconds (e.g., twice the RSVP in seconds) may be to skip transmitting/retransmitting in the first resource

$${R}_{1}^{( 3 )}$$

in the third SPS process 706 (as depicted by the unfilled slot at the subchannel understood to have previously represented the first resource in the third SPS process 706). In one example the change to the third SPS process 706 may be to abstain from transmitting in the first resource in the

$${R}_{1}^{( 3 )} 751$$

in the third SPS process 706 (and optionally receive, sense, listen during that resource) and/or to add a new/different first resource (e.g., ALT

$${R}_{1}^{( 3 )}$$

as shown in FIG. 7). In some examples, the value of x (as measured by the timer/counter 730) may be dependent on a speed (e.g., a velocity of travel) of the user equipment and/or other channel link status measurements. For example, when the UE (e.g., as carried by or integral to a vehicle) has a velocity less than 30 km/h, x=3; and greater than 60 km/h, x=1.

As a second example, the timer/counter 730 may count a quantity of contiguous SPS processes (e.g., N process) during which a same resource was continually used. Upon reaching the value of N, the UE may change at least one aspect of one or more SPS processes, or change a given previously set parameter, such as a previously set and previously existing SPS Resource Reselection Counter 732. For example, in FIG. 7, if N=2, then upon reaching the value of 2 at the conclusion of the second SPS process 704, the UE may change at least one aspect of the third SPS process 706 such as shown and described in connection with the first example, given immediately above. Alternatively, or additionally, the timer/counter 730 may exert a reset 734 to an already existing timer or counter, such as an SPS Resource Reselection Counter 732, without (e.g., before) the SPS Resource Reselection Counter 732 reaching its predetermined value (where, upon reaching the predetermined value) the SPS Resource Reselection Counter 732 cause an execution of a resource selection trigger 402.

As a third example, a UE could reuse the SPS Resource Reselection Counter 732 to trigger a change to at least one SPS process. For example, the UE may trigger the change to the at least one SPS process whenever the SPS Resource Reselection Counter 732 indicated a given value without regard to whether a resource reselection is triggered.

According to some aspects, certain SPS resource selection/reselection triggering criteria may be employed. For example, as indicated above a UE may reselect an SPS resource to avoid a collision. However, too frequent reselection may destabilize an interference pattern of the system and may produce more interference and collisions. Accordingly, in some examples, upon detection of an SPS resource collision, a criteria may be established so that the UE may reselect the potentially collided SPS resource if a measured RSRP of the SCI-1 carrying the reservation signal in the SPS resource is larger than a predetermined threshold.

According to such criteria, for example, in response to a measured SCI-1 RSRP being lower than the predetermined threshold, the transmitting UE may continue to use the potentially collided same SPS resource under an assumption that the predetermined threshold is sufficiently low so that a neighbor user equipment receiving both an SCI-1 (at a low, weak power level) from the interfering UE and the desired SCI-1 from the transmitting UE would be likely able to decode of the desired SCI-1 from the transmitting UE, even in the presence of the SCI-1 from the interfering UE. Such criteria may be useful, for example, when system load is high.

For example, it may be understood that a reselection triggering threshold

$${R}_{SPS}^{re - sel}$$

is a function of CBR. Accordingly, a higher

$${R}_{SPS}^{re - sel}$$

may be adopted when the CBR is high. A higher CBR implies a higher system load; in such an environment, a UE reselected new resource may be prone to collide with another UE(s).

In another example, the reselection triggering threshold

$${R}_{SPS}^{re - sel}$$

may be the RSRP threshold RSRPₜₕᵣ used for the resource selection process discussed herein. For example, the UE may increase the threshold by 3 dB to find enough free resources, e.g., 20% of the available resources are found when RSRP threshold RSRPₜₕᵣ=−86 dBm. Therefore, in one example the reselection triggering threshold

$${R}_{SPS}^{re - sel}$$

may be set to (RSRPₜₕᵣ+RSRP_{gap}) dBm, where RSRP_{gap} may be 3 or 6 dB in some examples.

In another example, the RSRP threshold may be adjusted according to packet/application priority. For example, a higher priority packet collision may be avoided by the UE if the UE detects a collision with a lower RSRP but a higher priority (e.g., as indicated in the SCI-1 transmitted by the interfering UE in comparison the SCI-1 of the UE). In response to this situation, the UE may trigger resource reselection to avoid producing interference, for example to a high QoS demand packet.

Described herein may be examples of ways to avoid continuous collisions between neighboring UEs unknowingly transmitting resource reservations for and on the same resources. For example, a UE may, from time to time, based on certain timers, counters, or circumstance, change the resources in one or more SPS processes. The change may allow the UE to sense (e.g., receive and measure) interfering signals, if any, that may be present on a previously, or potentially reserved resource. If the UE detects any other UEs transmitting reservation signals on the same resource(s) reserved by the UE, the UE may reselect resource(s) to avoid the periodic collisions. By way of example and not limitation, some ways to change the SPS process(es) may include stopping the transmission (i.e., the signaling) of a resource reservation period (RSVP) in an SCI-1 associated with a first transmission on a first resource in a given SPS process, so the first transmission on the corresponding first resource in the next SPS process can be omitted (and the UE may sense if any interference is present on the corresponding first resource in the next SPS process). According to another example, a UE may skip transmitting on one SPS resource for one SPS process, and transmit on another, randomly selected SPS resource in the same SPS process. According to another example, the UE may skip some SPS resource(s) for one SPS process, and optionally select replacement SPS resource(s) for the skipped SPS resource(s). These and other examples are further explained throughout the disclosure.

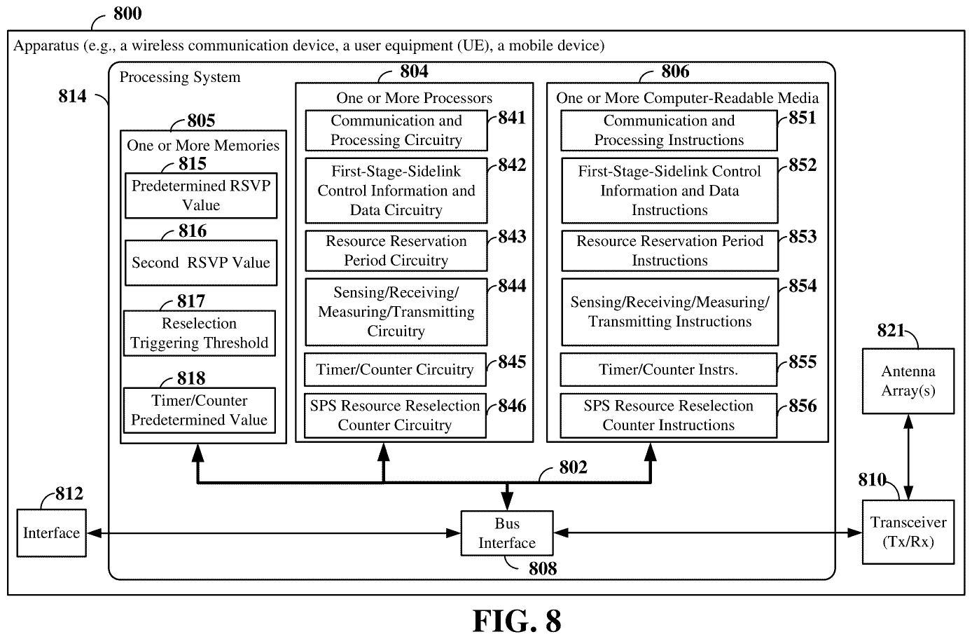

FIG. 8 is a block diagram illustrating an example of an apparatus 800 (e.g., a hardware implementation of a wireless communication device, a user equipment (UE), a mobile device, a vehicle equipped for 5G NR V2X communication) employing one or more processors 804 and one or more memories 805 according to some aspects of the disclosure. The apparatus 800 may be similar to, for example, any of the wireless communication devices, UEs, mobile devices, scheduled entities, vehicles (e.g., equipped for 5G NR V2X communication), roadside units of FIGS. 1 and/or 2.

In accordance with various aspects of the disclosure, an element, any portion of an element, or any combination of elements may be implemented with a processing system 814 that includes one or more processors 804. Examples of the one or more processors 804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the apparatus 800 may be configured to perform any one or more of the functions described herein. That is, the one or more processors 804, as utilized in the apparatus 800, may be configured to, individually or collectively, based at least in part on information stored in the one or more memories 805, implement any one or more methods or processes described and illustrated, for example, in FIGS. 4, 5, 6, 7, 9, 10, 11, and/or 12.

In this example, the processing system 814 may be implemented with a bus architecture, represented generally by the bus 802. The bus 802 may include any number of interconnecting buses and bridges depending on the specific application of the processing system 814 and the overall design constraints. The bus 802 communicatively couples together various circuits, comprising the one or more processors 804, the one or more memories 805, and the one or more computer-readable media 806. The bus 802 may also link various other circuits such as timing sources, peripherals, voltage regulators, and power management circuits, which are well known to persons having ordinary skill in the art, and, therefore, will not be described any further.

A bus interface 808 provides an interface between the bus 802 and a transceiver 810. The transceiver 810 may be, for example, a wireless transceiver. The transceiver 810 may be operational with multiple RATs (e.g., LTE, 5G NR, IEEE 802.11 (WiFi®), etc.). The transceiver 810 may provide respective means for communicating with various other apparatus, UEs, and core networks over a transmission medium (e.g., air interface). The transceiver 810 may be coupled to one or more respective antenna array(s) 821. The bus interface 808 may provide an interface between the bus 802 and a user interface 812 (e.g., keypad, display, touch screen, speaker, microphone, control features, vibration circuit/device, etc.). Of course, such a user interface 812 is optional and may be omitted in some examples.

One or more processors 804 may be configured to, individually or collectively, based at least in part on information stored in the one or more memories 805 (and/or the one or more computer-readable media 806) may be responsible for managing the bus 802 and general processing, including the execution of software stored on the one or more memories 805 and/or the one or more computer-readable media 806. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the one or more memories 805 and/or the one or more computer-readable media 806. The software, when executed by the one or more processors 804, individually or collectively, may cause the processing system 814 to perform the various processes and functions described herein for any particular apparatus.

The one or more computer-readable media 806 may each be a non-transitory computer-readable medium and may be referred to as a computer-readable storage medium or a non-transitory computer-readable medium. The non-transitory computer-readable medium may store computer-executable code (e.g., processor-executable code). The computer executable code may include code for causing a computer (e.g., the one or more processors 804) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The one or more computer-readable media 806 may reside in the processing system 814, external to the processing system 814, or distributed across multiple entities, including the processing system 814. The one or more computer-readable media 806 may be embodied in a computer program product or article of manufacture. By way of example, a computer program product or article of manufacture may include a computer-readable medium in packaging materials. In some examples, the one or more computer-readable media 806 may be part of the one or more memories 805.

Persons having ordinary skill in the art will recognize how best to implement the described functionality presented throughout this disclosure depending on the particular application and the overall design constraints imposed on the overall system. The one or more computer-readable media 806 and/or the one or more memories 805 may also be used for storing data that is manipulated by the one or more processors 804 when executing software. For example, the one or more memories 805 may store one or more various values and/or thresholds that may be used in determining whether to change one or more SPS processes according to some aspects of the disclosure.

In some aspects of the disclosure, the one or more processors 804 may include communication and processing circuitry 841 configured for various functions, comprising, for example, communicating with another wireless communication device, for example via 5G NR V2X sidelink or other communication standards, a network entity, and/or a core network. In some examples, the communication and processing circuitry 841 may include one or more hardware components that provide the physical structure that performs processes related to wireless communication (e.g., signal reception and/or signal transmission) and signal processing (e.g., processing a received signal and/or processing a signal for transmission). The communication and processing circuitry 841 may further be configured to execute communication and processing instructions 851 (e.g., software) stored on the one or more computer-readable media 806 to implement one or more functions described herein.

In some aspects of the disclosure, the one or more processors 804 may include first-stage-sidelink control information and data circuitry 842 configured for various functions, comprising, for example, configuring a first first-stage-sidelink control information (first SCI-1) and data, the data being, for example, a transport block (TB) and the first SCI-1 comprising, for example, a first resource reservation information reserving the first resource in a first SPS process and omitting a first resource reservation period (RSVP). In another aspect, the first-stage-sidelink control information and data circuitry 842 may be configured for various functions, including, for example, configuring a second SCI-1 comprising a second resource reservation information reserving at least one subsequent resource in the first SPS process and comprising a second RSVP having a second RSVP value greater than zero and indicative of a semi-persistent scheduling of the data (e.g., the TB). In another aspect, the first-stage-sidelink control information and data circuitry 842 may be configured for various functions, such as including the first RSVP in the first SCI-1, where the first RSVP is a predetermined value indicative of an absence of the semi-persistent scheduling of the data in a subsequent first resource in a second SPS process, the subsequent first resource separated in time from the first resource by the second RSVP value. The first-stage-sidelink control information and data circuitry 842 may further be configured to execute first-stage-sidelink control information and data instructions 852 (e.g., software) stored on the one or more computer-readable media 806 to implement one or more functions described herein.

In some aspects of the disclosure, the one or more processors 804 may include resource reservation period (RSVP) circuitry 843 configured for various functions, including, for example, obtaining the first RSVP predetermined value indicative of an absence of the semi-persistent scheduling of the data in a subsequent first resource in a second SPS process, the subsequent first resource separated in time from the first resource by the second RSVP value. The RSVP circuitry may also be configured for various functions, including, for example, obtaining the second RSVP having the second RSVP value greater than zero and indicative of a semi-persistent scheduling of the data. In some examples, the RSVP predetermined value may be stored in a predetermined RSVP value 815 location in the one or more memories 805. In some examples the predetermined value is zero. In some examples, the second RSVP value may be stored in a second RSVP value 816 location in the one or more memories 805. In some examples, the second RSVP value may be greater than zero and indicative of a semi-persistent scheduling of the data. The resource reservation period circuitry 843 may further be configured to execute RSVP instructions 853 (e.g., software) stored on the one or more computer-readable media 806 to implement one or more functions described herein.

In some aspects of the disclosure, the one or more processors 804 may include sensing/receiving/measuring/transmitting circuitry 844, which, in combination with the communication and processing circuitry 841, the transceiver 810, and the antenna array(s) 821, which may be configured for various functions, including, for example, sensing, by receiving in a following resource in a second SPS process, a third SCI-1 transmitted by a neighbor user equipment, the following resource corresponding to the first resource shifted in time by the second RSVP. The sensing/receiving/measuring/transmitting circuitry 844, in combination with the communication and processing circuitry 841, the transceiver 810, and the antenna array(s) 821 may further be configured for transmitting in a first resource in the third SPS process a fourth first-stage-sidelink control information (fourth SCI-1) and the data, the fourth SCI-1 comprising a next resource reservation information reserving at least the first resource in the third SPS process and comprising the second RSVP, the first resource in the third SPS process corresponding to the first resource of the first SPS process shifted in time by twice the second RSVP, the transmitting in response to a reference signal power (RSRP) associated with the third SCI-1 being less than a reselection triggering threshold. According to some aspects, the reselection triggering threshold may be a function of a channel busy ratio (CBR). According to some aspects, the reselection triggering threshold may be stored in a reselection triggering threshold location 817 of the one or more memories 805. In some examples, the reselection triggering threshold may be set equal to an RSRP threshold plus a gap value of 3 dB or 6 dB. In various examples the sensing/receiving/measuring/transmitting circuitry 844, in combination with the communication and processing circuitry 841, the transceiver 810, and the antenna array(s) 821 may be configured to transmit in a first resource, the first SCI-1 and the data, and transmit in at least one subsequent resource, the second SCI-1 and the data.

In some aspects of the disclosure, the sensing/receiving/measuring/transmitting circuitry 844, in combination with the communication and processing circuitry 841, the transceiver 810, and the antenna array(s) 821, may be configured to sense, by receiving, one or more other UEs' first-stage-sidelink control information in a resource available for sidelink communication, in a sensing window, and transmit, in a resource selection window, a first first-stage-sidelink control information (first SCI-1) and data in selected resources in a plurality of SPS processes, each of the resources may be selected based on the sensing in the sensing window. In some examples, the sensing/receiving/measuring/transmitting circuitry 844, in combination with the communication and processing circuitry 841, the transceiver 810, and the antenna array(s) 821, may be configured to decode the one or more other UEs' SCI-1(s), measure an RSRP associated with each respective decoded SCI-1, and select the selected resources based in part on a value of the RSRP being less than a predetermined RSRP threshold value. The sensing/receiving/measuring/transmitting circuitry 844 may further be configured to execute sensing/receiving/measuring/transmitting instructions 854 (e.g., software) stored on the one or more computer-readable media 806 to implement one or more functions described herein.

In some aspects of the disclosure, the one or more processors 804 may include timer/counter circuitry 845 (such as the timer/counter 730 as shown and described in connection with FIG. 7) configured for various functions, including, for example, in combination with the communication and processing circuitry 841, initiating a timer/counter (i.e., the timer/counter circuitry 845) at a start of a first SPS process of a plurality of SPS processes, and change at least one SPS process of the plurality of SPS processes based at least in part on an elapsed time/count indicated by the timer/counter. In some examples, the timer/counter circuitry 845, in combination with the communications and processing circuitry 841, for example, may be configured to select a random value of time and change the at least one SPS process of the plurality of SPS processes in response to an elapsed time of the timer/counter equaling the random value of time. In some examples, the timer/counter circuitry 845, in combination with the communications and processing circuitry 841, for example, may be configured to select a resource selection trigger time based on a speed of the apparatus, and change the at least one SPS process of the plurality of SPS processes in response to an elapsed time of the timer/counter equaling the resource selection trigger time. According to some aspects, increasing the speed of the apparatus decreases the resource selection trigger time. In some examples, the timer/counter circuitry 845, in combination with the communications and processing circuitry 841, for example, may be configured to increment a value of the timer/counter each time an SPS process concludes, and change the at least one SPS process of the plurality of SPS processes when the value of the timer/counter equals a predetermined value. In some examples, the timer/counter predetermined value may be stored in a timer/counter predetermined value location 818 stored on the one or more memories 805. In one example, the timer/counter (i.e., the timer/counter circuitry 845) counts SPS processes. The timer/counter circuitry 845, in combination with the communications and processing circuitry 841, for example, may be configured to increment a first value of the timer/counter each time an SPS process concludes, and trigger the changing of the at least one of the plurality of SPS resources in response to the first value of the timer/counter reaching a predetermined value independently of a second value of an SPS Resource Reselection Counter 846 (such as the SPS Resource Reselection Counter 732 as shown and described in connection with FIG. 7) reaching a resource reselection trigger value. The SPS Resource Reselection Counter 846 may further be configured to execute SPS Resource Reselection Counter instructions 856 (e.g., software) stored on the one or more computer-readable media 806 to implement one or more functions described herein. The timer/counter circuitry 845 may further be configured to execute timer/counter instructions 855 (e.g., software) stored on the one or more computer-readable media 806 to implement one or more functions described herein.

In general, an apparatus, such as the apparatus 800, may include one or more memories 805 (and one or more computer-readable media 806) and one or more processors 804, the one or more processors 804 may be configured to, individually or collectively, based at least in part on information stored in the one or more memories 805 (and/or the one or more computer-readable media 806), perform any of the processes described herein.

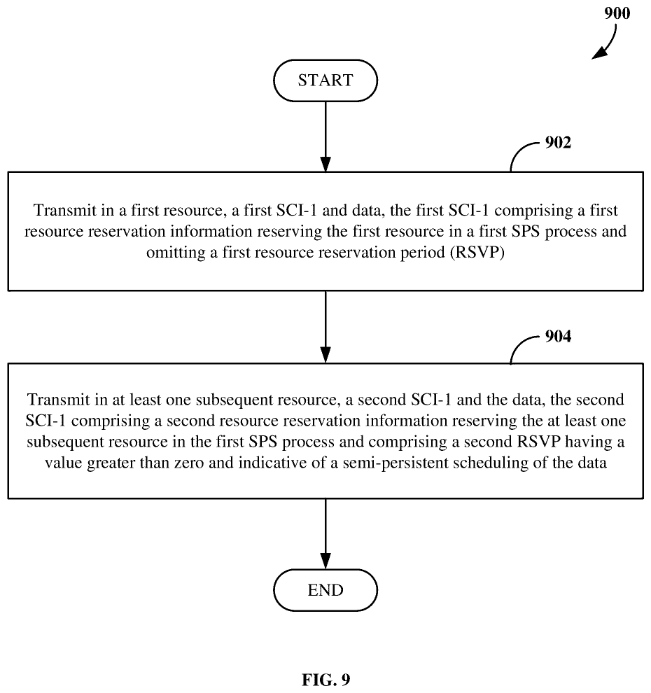

FIG. 9 is a flow chart illustrating an example method 900 (e.g., a process) at an apparatus (e.g., a hardware implementation of a wireless communication device, a user equipment (UE), a mobile device, a vehicle equipped for 5G NR V2X communication) according to some aspects of the disclosure. As described below, some or all illustrated features may be omitted in a particular implementation within the scope of the present disclosure, and some illustrated features may not be required for implementation of all examples. In some examples, the method 900 may be carried out by the apparatus 800 as illustrated and described in connection with FIG. 8. The apparatus 800 may be similar to, for example, any of the UEs, mobile devices, scheduled entities, or sidelink UEs as shown and described in connection with FIGS. 1 and/or 2. In some examples, the method 900 may be carried out by any suitable apparatus or means for carrying out the functions or algorithm described below.

At block 902, the apparatus may transmit in a first resource, a first first-stage-sidelink control information (first SCI-1) and data (e.g., a TB), the first SCI-1 comprising a first resource reservation information reserving the first resource in a first SPS process and omitting a first resource reservation period (RSVP). For example, the first-stage-sidelink control information and data circuitry 842, in combination with the communication and processing circuitry 841, the sensing/receiving/measuring/transmitting circuitry 844, the transceiver 810, and/or the antenna array(s) 821, as shown and described in connection with FIG. 8, may provide a means for transmitting in a first resource, a first first-stage-sidelink control information (first SCI-1) and data (e.g., a TB), the first SCI-1 comprising a first resource reservation information reserving the first resource in a first SPS process and omitting a first resource reservation period (RSVP).

At block 904, the apparatus may transmit in at least one subsequent resource, a second first-stage-sidelink control information (second SCI-1) and the data, the second SCI-1 comprising a second resource reservation information reserving the at least one subsequent resource in the first SPS process and comprising a second RSVP having a second RSVP value greater than zero and indicative of a semi-persistent scheduling of the data. For example, the first-stage-sidelink control information and data circuitry 842, in combination with the communication and processing circuitry 841, the sensing/receiving/measuring/transmitting circuitry 844, the transceiver 810, and/or the antenna array(s) 821, as shown and described in connection with FIG. 8, may provide a means for transmitting in at least one subsequent resource, a second first-stage-sidelink control information (second SCI-1) and the data, the second SCI-1 comprising a second resource reservation information reserving the at least one subsequent resource in the first SPS process and comprising a second RSVP having a second RSVP value greater than zero and indicative of a semi-persistent scheduling of the data.

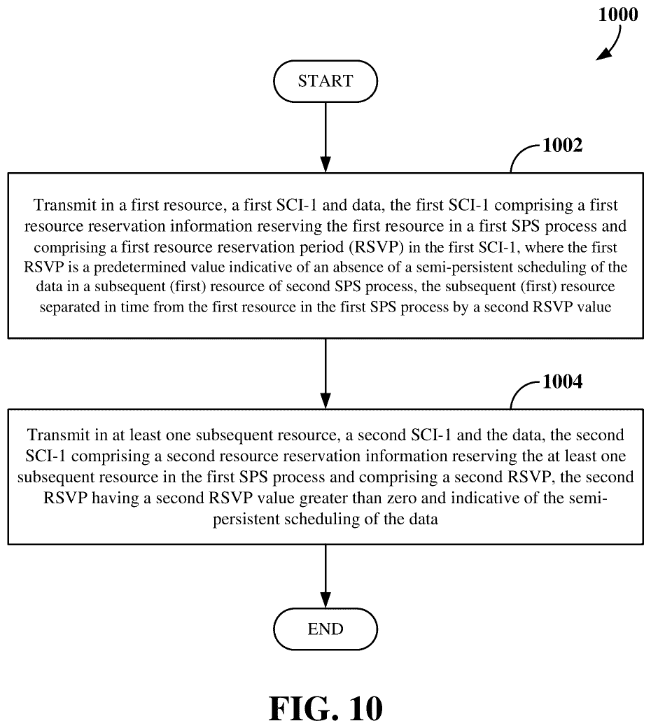

FIG. 10 is a flow chart illustrating an example method 1000 (e.g., a process) at an apparatus (e.g., a hardware implementation of a wireless communication device, a user equipment (UE), a mobile device, a vehicle equipped for 5G NR V2X communication) according to some aspects of the disclosure. As described below, some or all illustrated features may be omitted in a particular implementation within the scope of the present disclosure, and some illustrated features may not be required for implementation of all examples. In some examples, the method 1000 may be carried out by the apparatus 800 as illustrated and described in connection with FIG. 8. The apparatus 800 may be similar to, for example, any of the UEs, mobile devices, scheduled entities, or sidelink UEs as shown and described in connection with FIGS. 1 and/or 2. In some examples, the method 1000 may be carried out by any suitable apparatus or means for carrying out the functions or algorithm described below.

At block 1002, the apparatus may transmit in a first resource, a first first-stage-sidelink control information (first SCI-1) and data (e.g., a TB). In in lieu of omitting the first resource reservation period (RSVP) as in the block 902 of FIG. 9, the first SCI-1 includes the first resource reservation information reserving the first resource in a first SPS process and includes the first resource reservation period (RSVP) in the first SCI-1, where the first RSVP is a predetermined value indicative of an absence of a semi-persistent scheduling of the data in a subsequent first resource in a second SPS process, the subsequent first resource separated in time from the first resource by a second RSVP value. For example, the first-stage-sidelink control information and data circuitry 842, in combination with the communication and 1 processing circuitry 841, the sensing/receiving/measuring/transmitting circuitry 844, the transceiver 810, and/or the antenna array(s) 821, as shown and described in connection with FIG. 8, may provide a means for transmitting in a first resource, a first first-stage-sidelink control information (first SCI-1) and data, the first SCI-1 comprising the first resource reservation information reserving the first resource in a first SPS process and comprising the first resource reservation period (RSVP) in the first SCI-1, where the first RSVP is a predetermined value indicative of an absence of a semi-persistent scheduling of the data in a subsequent first resource in a second SPS process, the subsequent first resource separated in time from the first resource by a second RSVP value. According to some examples, the predetermined value may be zero.

At block 1004, the apparatus may transmit in at least one subsequent resource, a second first-stage-sidelink control information (second SCI-1) and the data, the second SCI-1 comprising a second resource reservation information reserving the at least one subsequent resource in the first SPS process and comprising a second RSVP having a second RSVP value greater than zero and indicative of a semi-persistent scheduling of the data. For example, the first-stage-sidelink control information and data circuitry 842, in combination with the communication and processing circuitry 841, the sensing/receiving/measuring/transmitting circuitry 844, the transceiver 810, and/or the antenna array(s) 821, as shown and described in connection with FIG. 8, may provide a means for transmitting in at least one subsequent resource, a second first-stage-sidelink control information (second SCI-1) and the data, the second SCI-1 comprising a second resource reservation information reserving the at least one subsequent resource in the first SPS process and comprising a second RSVP having a second RSVP value greater than zero and indicative of a semi-persistent scheduling of the data.

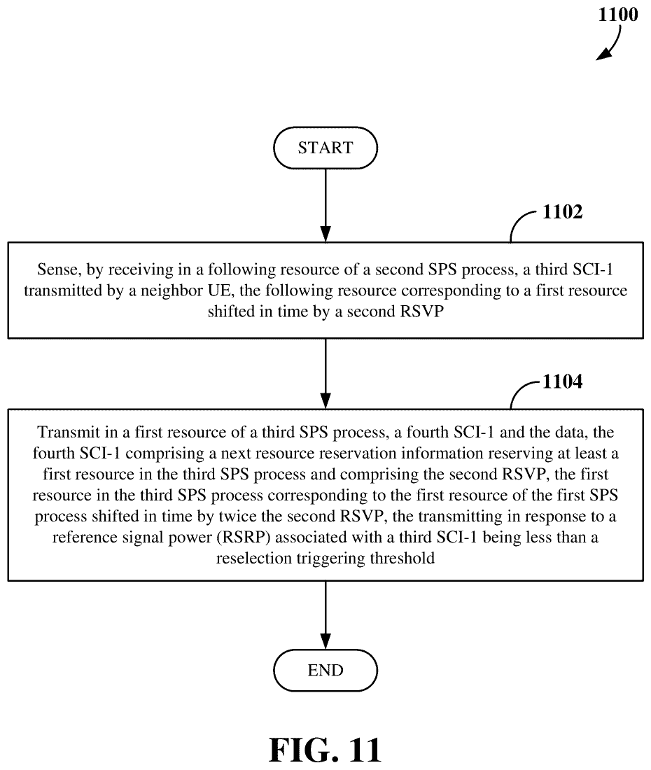

FIG. 11 is a flow chart illustrating an example method 1100 (e.g., a process) at an apparatus (e.g., a hardware implementation of a wireless communication device, a user equipment (UE), a mobile device, a vehicle equipped for 5G NR V2X communication) according to some aspects of the disclosure. As described below, some or all illustrated features may be omitted in a particular implementation within the scope of the present disclosure, and some illustrated features may not be required for implementation of all examples. In some examples, the method 1100 may be carried out by the apparatus 800 as illustrated and described in connection with FIG. 8. The apparatus 800 may be similar to, for example, any of the UEs, mobile devices, scheduled entities, or sidelink UEs as shown and described in connection with FIGS. 1 and/or 2. In some examples, the method 1100 may be carried out by any suitable apparatus or means for carrying out the functions or algorithm described below. The method 1100 of FIG. 11 may be carried out following either or both method 900 of FIG. 9 and method 1000 of FIG. 10.

At block 1102, the apparatus may sense, by receiving in a following resource in a second SPS process, a third SCI-1 transmitted by a neighbor user equipment, the following resource corresponding to the first resource shifted in time by the second RSVP. For example, the communication and processing circuitry 841, the resource reservation period circuitry 843, the sensing/receiving/measuring/transmitting circuitry 844, the transceiver 810, and/or the antenna array(s) 821, as shown and described in connection with FIG. 8, may provide a means for sensing, by receiving in a following resource in a second SPS process, a third SCI-1 transmitted by a neighbor user equipment, the following resource corresponding to the first resource shifted in time by the second RSVP.

At block 1104, the apparatus may transmit in a first resource in the third SPS process a fourth first-stage-sidelink control information (fourth SCI-1) and the data, the fourth SCI-1 comprising a next resource reservation information reserving at least the first resource in the third SPS process and comprising the second RSVP, the first resource in the third SPS process corresponding to the first resource of the first SPS process shifted in time by twice the second RSVP, the transmitting in response to a reference signal power (RSRP) associated with the third SCI-1 being less than a reselection triggering threshold. For example, the communication and processing circuitry 841, the resource reservation period circuitry 843, the sensing/receiving/measuring/transmitting circuitry 844, the transceiver 810, and/or the antenna array(s) 821, as shown and described in connection with FIG. 8, may provide a means for transmitting in a first resource in the third SPS process a fourth first-stage-sidelink control information (fourth SCI-1) and the data, the fourth SCI-1 comprising a next resource reservation information reserving at least the first resource in the third SPS process and comprising the second RSVP, the first resource in the third SPS process corresponding to the first resource of the first SPS process shifted in time by twice the second RSVP, the transmitting in response to a reference signal power (RSRP) associated with the third SCI-1 being less than a reselection triggering threshold. According to some examples, the reselection triggering threshold may be a function of a channel busy ratio (CBR). According to some examples, the reselection triggering threshold is set equal to an RSRP threshold plus a gap value of 3 dB or 6 dB.

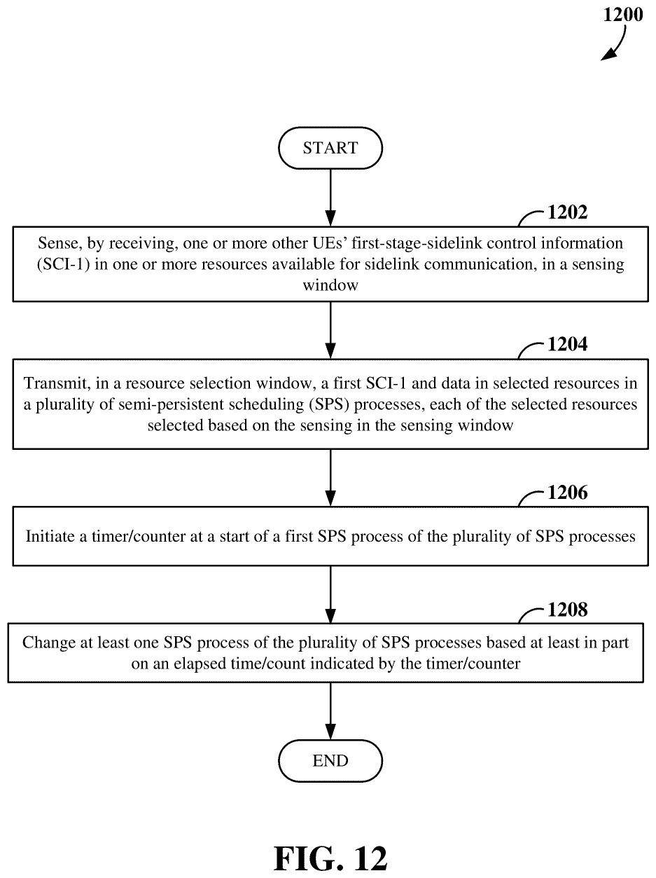

FIG. 12 is a flow chart illustrating an example method 1200 (e.g., a process) at an apparatus (e.g., a hardware implementation of a wireless communication device, a user equipment (UE), a mobile device, a vehicle equipped for 5G NR V2X communication) according to some aspects of the disclosure. As described below, some or all illustrated features may be omitted in a particular implementation within the scope of the present disclosure, and some illustrated features may not be required for implementation of all examples. In some examples, the method 1200 may be carried out by the apparatus 800 as illustrated and described in connection with FIG. 8. The apparatus 800 may be similar to, for example, any of the UEs, mobile devices, scheduled entities, or sidelink UEs as shown and described in connection with FIGS. 1 and/or 2. In some examples, the method 1200 may be carried out by any suitable apparatus or means for carrying out the functions or algorithm described below.

At block 1202, the apparatus may sense, by receiving, one or more other UEs' first-stage-sidelink control information (SCI-1) in one or more resources available for sidelink communication, in sensing a window. For example, the sensing/receiving/measuring/transmitting circuitry 844, in combination with the communication and processing circuitry 841, the transceiver 810, and/or the antenna array(s) 821 as shown and described in connection with FIG. 8, may provide a means for sensing, by receiving, one or more other UEs' first-stage-sidelink control information (SCI-1) in one or more resources available for sidelink communication, in a sensing window.

At block 1204, the apparatus may transmit, in a resource selection window, a first SCI-1 and data in selected resources in a plurality of semi-persistent scheduling (SPS) processes, each of the selected resources based on the sensing in the sensing window. For example, the sensing/receiving/measuring/transmitting circuitry 844, in combination with the communication and processing circuitry 841, the transceiver 810, and/or the antenna array(s) 821, as shown and described in connection with FIG. 8, may provide a means for transmitting, in a resource selection window, a first SCI-1 and data in selected resources in a plurality of semi-persistent scheduling (SPS) processes, each of the selected resources based on the sensing in the sensing window. In some examples, sensing includes receiving, and the method 1200 further includes decoding the one or more other apparatus' SCI-1, measuring a respective reference signal received power (RSRP) associated with each respective decoded one or more other apparatus' SCI-1, and selecting the selected resources based in part on a value of the respective RSRP being less than a predetermined RSRP threshold value.

At block 1206, the apparatus may initiate a timer/counter at a start of a first SPS process of the plurality of SPS processes. For example, the timer/counter circuitry 845, in combination with the communication and processing circuitry 841 as shown and described in connection with FIG. 8, may provide a means for initiating a timer/counter at a start of a first SPS process of the plurality of SPS processes.

At block 1208, the apparatus may change at least one SPS process of the plurality of SPS processes based at least in part on an elapsed time/count indicated by the timer/counter. For example, the timer/counter circuitry 845, in combination with the communication and processing circuitry 841, the first-stage-sidelink control information and data circuitry 842, and the resource reservation period circuitry 843, as shown and described in connection with FIG. 8, may provide a means for changing at least one SPS process of the plurality of SPS processes based at least in part on an elapsed time/count indicated by the timer/counter.

In some examples, the method 1200 may also include selecting a random value of time, and changing the at least one SPS process of the plurality of SPS processes in response to an elapsed time of the timer/counter equaling the random value of time. In other examples, the method 1200 may also include selecting a resource selection trigger time based on a speed of the apparatus, and changing the at least one SPS process of the plurality of SPS processes in response to an elapsed time of the timer/counter equaling the resource selection trigger time. According to some aspects, increasing the speed of the apparatus decreases the resource selection trigger time.

In some examples, the timer/counter counts SPS processes, and the method 1200 further includes incrementing a value of the timer/counter each time an SPS process concludes, and changing the at least one SPS process of the plurality of SPS processes when the value of the timer/counter equals a predetermined value. In other examples, the timer/counter counts SPS processes. The method 1200 further includes incrementing a first value of the timer/counter each time an SPS process concludes, and triggering the changing of the at least one of the plurality of SPS resources in response to the first value of the timer/counter reaching a predetermined value independently of a second value of an SPS Resource Reselection Counter reaching a resource reselection trigger value.

Of course, in the above examples, the circuitry included in the one or more processors 804 is merely provided as an example. Other means for carrying out the described functions may be included within various aspects of the present disclosure, including but not limited to the instructions stored in the one or more memories 805, the one or more computer-readable media 806, or any other suitable apparatus or means described in any one of the FIGS. 1, 2, and/or 8, and utilizing, for example, the processes and/or algorithms described herein in relation to FIGS. 4-7, 9-11, and/or 12.

The processes shown in FIGS. 4-7 and 9-12 may include additional aspects, such as any single aspect or any combination of aspects described below and/or in connection with one or more other processes described elsewhere herein.

Several aspects of a wireless communication network have been presented with reference to an exemplary implementation. As persons having ordinary skill in the art will readily appreciate, various aspects described throughout this disclosure may be extended to other telecommunication systems, network architectures and communication standards.

The following provides an overview of aspects of the present disclosure:

Aspect 1: A method, at an apparatus, comprising: transmitting in a first resource, a first first-stage-sidelink control information (first SCI-1) and data, the first SCI-1 comprising a first resource reservation information reserving the first resource in a first semi-persistent scheduling (SPS) process and omitting a first resource reservation period (RSVP), and transmitting in at least one subsequent resource, a second first-stage-sidelink control information (second SCI-1) and the data, the second SCI-1 comprising a second resource reservation information reserving the at least one subsequent resource in the first SPS process and comprising a second RSVP having a second RSVP value greater than zero and indicative of a semi-persistent scheduling of the data.

Aspect 2: The method of aspect 1, wherein, in lieu of omitting the first RSVP, the method further comprises: including the first RSVP in the first SCI-1, wherein the first RSVP is a predetermined value indicative of an absence of the semi-persistent scheduling of the data in a subsequent first resource in a second SPS process, the subsequent first resource separated in time from the first resource by the second RSVP value.

Aspect 4: The method of any of aspects 1 through 3, further comprising: sensing, by receiving in a following resource in a second SPS process, a third SCI-1 transmitted by a neighbor apparatus, the following resource corresponding to the first resource shifted in time by the second RSVP.

Aspect 3: The method of aspect 2, wherein the predetermined value is zero.

Aspect 5: The method of aspect 4, further comprising: transmitting in a first resource in the third SPS process a fourth first-stage-sidelink control information (fourth SCI-1) and the data, the fourth SCI-1 comprising a next resource reservation information reserving at least the first resource in the third SPS process and comprising the second RSVP, the first resource in the third SPS process corresponding to the first resource of the first SPS process shifted in time by twice the second RSVP, the transmitting in response to a reference signal power (RSRP) associated with the third SCI-1 being less than a reselection triggering threshold.

Aspect 6: The method of aspect 5, wherein the reselection triggering threshold is a function of a channel busy ratio (CBR).

Aspect 7: The method of any of aspects 1 through 6, wherein the reselection triggering threshold is set equal to an RSRP threshold plus a gap value of 3 dB or 6 dB.

Aspect 8: An apparatus, comprising: one or more memories, and one or more processors being configured to, individually or collectively, based at least in part on information stored in the one or more memories: transmit in a first resource, a first first-stage-sidelink control information (first SCI-1) and data, the first SCI-1 comprising a first resource reservation information reserving the first resource in a first semi-persistent scheduling (SPS) process and omitting a first resource reservation period (RSVP), and transmit in at least one subsequent resource, a second first-stage-sidelink control information (second SCI-1) and the data, the second SCI-1 comprising a second resource reservation information reserving the at least one subsequent resource in the first SPS process and comprising a second RSVP having a second RSVP value greater than zero and indicative of a semi-persistent scheduling of the data.

Aspect 9: The apparatus of aspect 8, wherein, in lieu of omitting the first RSVP, the one or more processors are further configured to: include the first RSVP in the first SCI-1, wherein the first RSVP is a predetermined value indicative of an absence of the semi-persistent scheduling of the data in a subsequent first resource in a second SPS process, the subsequent first resource separated in time from the first resource by the second RSVP value.

Aspect 10: The apparatus of aspect 9, wherein the predetermined value is zero.

Aspect 11: The apparatus of any of aspects 1 through 10, wherein the one or more processors are further configured to: sense, by receiving in a following resource in a second SPS process, a third SCI-1 transmitted by a neighbor apparatus, the following resource corresponding to the first resource shifted in time by the second RSVP.

Aspect 12: The apparatus of any of aspects 1 through 11, wherein the one or more processors are further configured to: transmitting in a first resource in the third SPS process a fourth first-stage-sidelink control information (fourth SCI-1) and the data, the fourth SCI-1 comprising a next resource reservation information reserving at least the first resource in the third SPS process and comprising the second RSVP, the first resource in the third SPS process corresponding to the first resource of the first SPS process shifted in time by twice the second RSVP, the transmitting in response to a reference signal power (RSRP) associated with the third SCI-1 being less than a reselection triggering threshold.

Aspect 13: The apparatus of aspect 12, wherein the reselection triggering threshold is a function of a channel busy ratio (CBR).

Aspect 14: The apparatus of any of aspects 1 through 12, wherein the reselection triggering threshold is set equal to an RSRP threshold plus a gap value of 3 dB or 6 dB.

Aspect 15: A method at an apparatus, comprising: sensing, by receiving, one or more other apparatus' first-stage-sidelink control information (SCI-1) in one or more resources available for sidelink communication, in a sensing window, transmitting, in a resource selection window, a first SCI-1 and data in selected resources in a plurality of semi-persistent scheduling (SPS) processes, each of the selected resources based on the sensing in the sensing window, initiating a timer/counter at a start of a first SPS process of the plurality of SPS processes, and changing at least one SPS process of the plurality of SPS processes based at least in part on an elapsed time/count indicated by the timer/counter.

Aspect 16: The method of aspect 15, wherein sensing comprises the receiving, and the method further comprises: decoding the one or more other apparatus' SCI-1, measuring a respective reference signal received power (RSRP) associated with each respective decoded one or more other apparatus' SCI-1, and selecting the selected resources based in part on a value of the respective RSRP being less than a predetermined RSRP threshold value.

Aspect 17: The method of aspect 15 or 16, further comprising: selecting a random value of time, and changing the at least one SPS process of the plurality of SPS processes in response to an elapsed time of the timer/counter equaling the random value of time.

Aspect 18: The method of any of aspects 15 through 17, further comprising: selecting a resource selection trigger time based on a speed of the apparatus, and changing the at least one SPS process of the plurality of SPS processes in response to an elapsed time of the timer/counter equaling the resource selection trigger time.

Aspect 19: The method of any of aspects 15 through 18, wherein increasing the speed of the apparatus decreases the resource selection trigger time.

Aspect 20: The method of any of aspects 15 through 19, wherein the timer/counter counts SPS processes, the method further comprising: incrementing a value of the timer/counter each time an SPS process concludes, and changing the at least one SPS process of the plurality of SPS processes when the value of the timer/counter equals a predetermined value.

Aspect 21: The method of any of aspects 15 through 20, wherein the timer/counter counts SPS processes, the method further comprising: incrementing a first value of the timer/counter each time an SPS process concludes, and triggering the changing of the at least one of the plurality of SPS resources in response to the first value of the timer/counter reaching a predetermined value independently of a second value of an SPS Resource Reselection Counter reaching a resource reselection trigger value.

Aspect 22: An apparatus, comprising: one or more memories, and one or more processors being configured to, individually or collectively, based at least in part on information stored in the one or more memories: sense, by receiving, one or more other apparatus' first-stage-sidelink control information (SCI-1) in one or more resources available for sidelink communication, in a sensing window, transmit, in a resource selection window, a first SCI-1 and data in selected resources in a plurality of semi-persistent scheduling (SPS) processes, each of the selected resources based on the sensing in the sensing window, initiate a timer/counter at a start of a first SPS process of the plurality of SPS processes, and change at least one SPS process of the plurality of SPS processes based at least in part on an elapsed time/count indicated by the timer/counter.

Aspect 23: The apparatus of aspect 22, wherein sensing comprises the receiving, and the one or more processors are further configured to: decode the one or more other apparatus' SCI-1, measure a respective reference signal received power (RSRP) associated with each respective decoded one or more other apparatus' SCI-1, and select the selected resources based in part on a value of the respective RSRP being less than a predetermined RSRP threshold value.

Aspect 24: The apparatus of aspect 22 or 23, wherein the one or more processors are further configured to: select a random value of time, and change the at least one SPS process of the plurality of SPS processes in response to an elapsed time of the timer/counter equaling the random value of time.

Aspect 25: The apparatus of any of aspects 22 through 24, wherein the one or more processors are further configured to: select a resource selection trigger time based on a speed of the apparatus, and change the at least one SPS process of the plurality of SPS processes in response to an elapsed time of the timer/counter equaling the resource selection trigger time.

Aspect 26: The apparatus of aspect 25, wherein increasing the speed of the apparatus decreases the resource selection trigger time.

Aspect 27: The apparatus of any of aspects 22 through 26, wherein the timer/counter counts SPS processes and the one or more processors are further configured to: increment a value of the timer/counter each time an SPS process concludes, and change the at least one SPS process of the plurality of SPS processes when the value of the timer/counter equals a predetermined value.

Aspect 28: The apparatus of any of aspects 22 through 26, wherein the timer/counter counts SPS processes and the one or more processors are further configured to: increment a first value of the timer/counter each time an SPS process concludes, and trigger the changing of the at least one of the plurality of SPS resources in response to the first value of the timer/counter reaching a predetermined value independently of a second value of an SPS Resource Reselection Counter reaching a resource reselection trigger value.

Aspect 30: An apparatus comprising at least one means for performing a method of any one of aspects 1 through 7 or 15 through 21.

Aspect 31: A non-transitory computer-readable medium storing computer-executable code, comprising code for causing an apparatus to perform a method of any one of aspects 1 through 7 or 15 through 21.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure. As used herein, terms such as “one or more other UEs” and “neighbor UEs” may be understood as references to one or more other apparatus or neighbor apparatus (e.g., a hardware implementation of a wireless communication device, a user equipment (UE), a mobile device, a vehicle equipped for 5G NR V2X communication).

One or more of the components, steps, features, and/or functions illustrated in FIGS. 1-12 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1, 2 and/or 8 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and is not meant to be limited to the specific order or hierarchy presented unless specifically recited therein.

The previous description is provided to enable any person having ordinary skill in the art to practice the various aspects described herein. Various modifications to these aspects will be readily apparent to those persons having ordinary skill in the art, and the generic principles defined herein may be applied to other aspects. Thus, the claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. The construct A and/or B is intended to cover A or B or A and B. All structural and functional equivalents to the elements of the various aspects described throughout this disclosure that are known or later come to be known to persons having ordinary skill in the art are expressly incorporated herein by reference and are intended to be encompassed by the claims. Moreover, nothing disclosed herein is intended to be dedicated to the public, regardless of whether such disclosure is explicitly recited in the claims.

1. A method, at an apparatus, comprising:
transmitting in a first resource, a first first-stage-sidelink control information (first SCI-1) and data, the first SCI-1 comprising a first resource reservation information reserving the first resource in a first semi-persistent scheduling (SPS) process and omitting a first resource reservation period (RSVP); and
transmitting in at least one subsequent resource, a second first-stage-sidelink control information (second SCI-1) and the data, the second SCI-1 comprising a second resource reservation information reserving the at least one subsequent resource in the first SPS process and comprising a second RSVP having a second RSVP value greater than zero and indicative of a semi-persistent scheduling of the data.

2. The method of claim 1, wherein, in lieu of omitting the first RSVP, the method further comprises:
including the first RSVP in the first SCI-1, wherein the first RSVP is a predetermined value indicative of an absence of the semi-persistent scheduling of the data in a subsequent first resource in a second SPS process, the subsequent first resource separated in time from the first resource by the second RSVP value.

3. The method of claim 2, wherein the predetermined value is zero.

4. The method of claim 1, further comprising:
sensing, by receiving in a following resource in a second SPS process, a third SCI-1 transmitted by a neighbor apparatus, the following resource corresponding to the first resource shifted in time by the second RSVP.

5. The method of claim 4, further comprising:
transmitting in a first resource in the third SPS process a fourth first-stage-sidelink control information (fourth SCI-1) and the data, the fourth SCI-1 comprising a next resource reservation information reserving at least the first resource in the third SPS process and comprising the second RSVP, the first resource in the third SPS process corresponding to the first resource of the first SPS process shifted in time by twice the second RSVP, the transmitting in response to a reference signal power (RSRP) associated with the third SCI-1 being less than a reselection triggering threshold.

6. The method of claim 5, wherein the reselection triggering threshold is a function of a channel busy ratio (CBR).

7. (canceled)

8. An apparatus, comprising:
one or more memories; and
one or more processors being configured to, individually or collectively, based at least in part on information stored in the one or more memories:
transmit in a first resource, a first first-stage-sidelink control information (first SCI-1) and data, the first SCI-1 comprising a first resource reservation information reserving the first resource in a first semi-persistent scheduling (SPS) process and omitting a first resource reservation period (RSVP), and
transmit in at least one subsequent resource, a second first-stage-sidelink control information (second SCI-1) and the data, the second SCI-1 comprising a second resource reservation information reserving the at least one subsequent resource in the first SPS process and comprising a second RSVP having a second RSVP value greater than zero and indicative of a semi-persistent scheduling of the data.

9. The apparatus of claim 8, wherein, in lieu of omitting the first RSVP, the one or more processors are further configured to:
include the first RSVP in the first SCI-1, wherein the first RSVP is a predetermined value indicative of an absence of the semi-persistent scheduling of the data in a subsequent first resource in a second SPS process, the subsequent first resource separated in time from the first resource by the second RSVP value.

10. The apparatus of claim 9, wherein the predetermined value is zero.

11. The apparatus of claim 8, wherein the one or more processors are further configured to:
sense, by receiving in a following resource in a second SPS process, a third SCI-1 transmitted by a neighbor apparatus, the following resource corresponding to the first resource shifted in time by the second RSVP.

12. The apparatus of claim 11, wherein the one or more processors are further configured to:
transmitting in a first resource in the third SPS process a fourth first-stage-sidelink control information (fourth SCI-1) and the data, the fourth SCI-1 comprising a next resource reservation information reserving at least the first resource in the third SPS process and comprising the second RSVP, the first resource in the third SPS process corresponding to the first resource of the first SPS process shifted in time by twice the second RSVP, the transmitting in response to a reference signal power (RSRP) associated with the third SCI-1 being less than a reselection triggering threshold.

13. The apparatus of claim 12, wherein the reselection triggering threshold is a function of a channel busy ratio (CBR).

14. The apparatus of claim 12, wherein the reselection triggering threshold is set equal to an RSRP threshold plus a gap value of 3 dB or 6 dB.

15-21. (canceled)

22. An apparatus, comprising:
one or more memories; and
one or more processors being configured to, individually or collectively, based at least in part on information stored in the one or more memories:
sense, by receiving, one or more other apparatus' first-stage-sidelink control information (SCI-1) in one or more resources available for sidelink communication, in a sensing window,
transmit, in a resource selection window, a first SCI-1 and data in selected resources in a plurality of semi-persistent scheduling (SPS) processes, each of the selected resources based on the sensing in the sensing window,
initiate a timer/counter at a start of a first SPS process of the plurality of SPS processes, and
change at least one SPS process of the plurality of SPS processes based at least in part on an elapsed time/count indicated by the timer/counter.

23. The apparatus of claim 22, wherein sensing comprises the receiving, and the one or more processors are further configured to:
decode the one or more other apparatus' SCI-1;
measure a respective reference signal received power (RSRP) associated with each respective decoded one or more other apparatus' SCI-1; and
select the selected resources based in part on a value of the respective RSRP being less than a predetermined RSRP threshold value.

24. The apparatus of claim 22, wherein the one or more processors are further configured to:
select a random value of time; and
change the at least one SPS process of the plurality of SPS processes in response to an elapsed time of the timer/counter equaling the random value of time.

25. The apparatus of claim 22, wherein the one or more processors are further configured to:
select a resource selection trigger time based on a speed of the apparatus; and
change the at least one SPS process of the plurality of SPS processes in response to an elapsed time of the timer/counter equaling the resource selection trigger time.

26. The apparatus of claim 25, wherein increasing the speed of the apparatus decreases the resource selection trigger time.

27. The apparatus of claim 22, wherein the timer/counter counts SPS processes and the one or more processors are further configured to:
increment a value of the timer/counter each time an SPS process concludes; and
change the at least one SPS process of the plurality of SPS processes when the value of the timer/counter equals a predetermined value.

28. The apparatus of claim 22, wherein the timer/counter counts SPS processes and the one or more processors are further configured to:
increment a first value of the timer/counter each time an SPS process concludes; and
trigger the changing of the at least one of the plurality of SPS resources in response to the first value of the timer/counter reaching a predetermined value independently of a second value of an SPS Resource Reselection Counter reaching a resource reselection trigger value.
